(19) United States
(12) Patent Application Publication
(10) Pub. No.: US 2015/0066853 A1
(43) Pub. Date: Mar. 5, 2015

(54) TEMPLATES AND MAPPINGS FOR USER SETTINGS

(71) Applicant: U-Me Holdings LLC, Carthage, MO (US)

(72) Inventor: Derek P. Martin, Carthage, MO (US)

(21) Appl. No.: 14/462,523

(22) Filed: Aug. 18, 2014

Related U.S. Application Data
(63) Continuation-in-part of application No. 14/016,038, filed on Aug. 30, 2013.

(51) Int. Cl. G06F 17/30

(52) U.S. Cl. CPC G06F 17/30575
USPC 707/626

(57) ABSTRACT

A cloud-based computer system changes the modern paradigm from being device-centric to being person-centric. The system makes all user data, settings, and licensed content for a user available in the cloud. Multiple templates provide mapping information from physical devices to a master template that serves as a central repository for all of a user's settings for all of a user's devices. The templates also provide mapping information that allow for mapping settings between different physical devices, between physical devices and other templates, and between templates. A user settings mechanism uses the mapping information to propagate user settings stored in one template to other templates and to one or more physical devices, and to propagate user settings stored in a physical device to multiple templates, including a master template that serves as the central repository for all of a user's settings.

### BACKGROUND

1. Technical Field

This disclosure generally relates to user settings for devices such as computers and mobile phones, and more specifically relates to templates for mapping user settings between devices and for providing a central repository for all of a user's settings on all of a user's devices.

2. Background Art

Modern technology has greatly simplified many aspects of our lives. For example, the Internet has made vast amounts of information available at the click of a mouse. Smart phones allow not only making phone calls, but also provide a mobile computing platform by providing the ability to run apps, view e-mail, and access many different types of information, including calendar, contacts, etc.

The evolution of modern technology has resulted in a world that is “device-centric.” This means each device must be configured to a user's needs. If a user owns a smart phone, tablet computer, and laptop computer, the user must take the time to configure each of these devices to his or her liking. This effort represents a significant investment of time for the user. For example, let's assume a user has been using the iPhone 4 for over a year, and decides to change to the Samsung Galaxy S4 phone. Depending on the vendor of the Samsung Galaxy S4 phone, the vendor may be able to transfer the phone contacts on the iPhone 4 to the new Samsung phone, but none of the apps or other data can be transferred. As a result, the decision to change to a new smart phone platform will require hours of time for the user to download apps and configure the new phone to his or her liking. The same problem exists when a user buys a new computer. The user must take the time to install all the software the user wants to use on the computer, and must take the time to configure the desired settings and preferences on the new computer. Again, this can be a very time-consuming proposition. It is not unusual for a user to spend many hours installing software and configuring a new computer system to his or her liking. For professionals who do not have the support of an IT department, taking the time to configure a new computer system either takes hours out of their work day, or takes hours of their personal time after work. In either case, the user loses hours of valuable time setting up a new computer system.

Not only must a user configure each of his or her devices, the configuration and capabilities of each device differ greatly. Apps installed on a smart phone are not made to run on a laptop or desktop computer. Software installed on a desktop or laptop computer are not made to run on smart phones. The result is the user must configure each device and install the software or apps to make the device as functional as the user needs it to be. This requires significant thought and expertise from the user to know how to configure each device.

### BRIEF SUMMARY

A cloud-based computer system changes the modern paradigm from being device-centric to being person-centric. The system makes all user data, settings, and licensed content for a user available in the cloud. Multiple templates provide mapping information from physical devices to a master template that serves as a central repository for all of a user's settings for all of a user's devices. The templates also provide mapping information that allow for mapping settings between different physical devices, between physical devices and other templates, and between templates. A user settings mechanism uses the mapping information to propagate user settings stored in one template to other templates and to one or more physical devices, and to propagate user settings stored in a physical device to multiple templates, including a master template that serves as a central repository for all of a user's settings.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is block diagram showing the Universal Me (U-Me) system;

FIG. 2 is block diagram showing additional details of the U-Me system;

FIG. 3 is block diagram showing a computer system that runs the U-Me system;

FIG. 4 is a block diagram showing how a user using a physical device can access information in the U-Me system;

FIG. 5 is a block diagram showing various features of the U-Me system;

FIG. 6 is a block diagram showing examples of user data;

FIG. 7 is a block diagram showing examples of user licensed content;

FIG. 8 is a block diagram showing examples of user settings;

FIG. 9 is a block diagram showing examples of universal templates;

FIG. 10 is a block diagram showing examples of device-specific templates;

FIG. 11 is a block diagram showing examples of phone templates;

FIG. 12 is a block diagram showing examples of tablet templates;

FIG. 13 is a block diagram showing examples of laptop templates;

FIG. 14 is a block diagram showing examples of desktop templates;

FIG. 15 is a block diagram showing examples of television templates;

FIG. 16 is a block diagram showing examples of software templates;

FIG. 17 is a block diagram showing examples of vehicle templates;

FIG. 18 is a block diagram showing examples of home automation templates;

FIG. 19 is a block diagram showing examples of gaming system templates;

FIG. 20 is a block diagram showing examples of audio system templates;

FIG. 21 is a block diagram showing examples of security system templates;

FIG. 22 is a block diagram showing examples of device interfaces;

FIG. 23 is a block diagram of a universal user interface;

FIG. 24 is a flow diagram of a method for programming a physical device with settings from the U-Me system;

FIG. 25 is a flow diagram of a first suitable method for performing step 2410 in FIG. 24 using a mapping between two physical devices;

FIG. 26 is a block diagram showing the generation of settings for Device2 from settings for Device 1 as shown in the flow diagram in FIG. 25;

FIG. 27 is a flow diagram of a second suitable method for performing step 2410 in FIG. 24 using a universal template;

FIG. 28 is a block diagram showing the generation of settings for Device2 from a universal template as shown in the flow diagram in FIG. 27;

FIG. 29 is a flow diagram of a third suitable method for performing step 2410 in FIG. 24 using settings from a first device and a universal template;

FIG. 30 is a block diagram showing the generation of settings for Device2 as shown in the flow diagram in FIG. 29;

FIG. 31 is a table showing mapping of some channel numbers for DirecTV to channel numbers for Dish Network;

FIG. 32 is a table showing examples of user television settings;

FIG. 33 is a flow diagram of a method for converting channel numbers for Dish Network to channel numbers for DirecTV;

FIG. 34 is a block diagram showing multiple levels of templates for user settings;

FIG. 35 is a block diagram showing multiple levels of templates and mappings for user settings;

FIG. 36 is a flow diagram of a method for propagating a user setting from a physical device to multiple templates;

FIG. 37 is a flow diagram of a method for propagating a user setting from the master template to one or more other templates and to a physical device;

FIG. 38 is a flow diagram of a method for resolving an incompatibility between user settings in different devices;

FIG. 39 is a block diagram showing multiple levels of templates and multiple physical devices; and

FIG. 40 is a block diagram showing multiple levels of templates and mappings for user settings that include multiple levels of universal templates.

### DETAILED DESCRIPTION

The evolution of technology has resulted in a device-centric world. Early desktop computer systems allowed a user to define certain settings or preferences that defined how the computer system functioned. This trend has continued to our modern times. Each computer system allows installing software according to the user's needs, and allows setting numerous settings or preferences that define how the computer system functions. A user who buys a new computer system typically must spend many hours installing software and setting user preferences and settings to get the computer system to a state where it is usable according to the user's needs.

The same device-centric approach has been used with cell phones, and now with smart phones. When a user purchases a new phone, the user typically must spend many hours installing apps and setting the appropriate preferences and settings so the smart phone will perform the functions the user desires. Some phone vendors provide a service that can transfer a person's contacts from their old phone to the new phone, and some provide a backup service for those contacts should the person lose or damage their phone. This backup service, however, typically backs up only the contacts, and does not back up apps or settings on the phone. Thus, even with the backup service, when a user gets a new phone, the user still spends hours downloading and installing apps, ringtones, etc. and setting all the system settings to configure the phone to the user's liking.

The disclosure herein presents a paradigm shift, from the device-centric world we live in today, to a person-centric world. This shift gives rise to many different opportunities that are not available in the world we live in today. A system called Universal Me (U-Me) disclosed herein is a cloud-based system that is person-centric. The U-Me system makes a user's data, licensed content and settings available in the cloud to any suitable device that user may choose to use.

The U-Me system provides multiple templates that provide mapping information from physical devices to a master template that serves as a central repository for all of a user's settings for all of a user's devices. The templates also provide mapping information that allow for mapping settings between different physical devices, between physical devices and other templates, and between templates. A user settings mechanism uses the mapping information to propagate user settings stored in one template to other templates and to one or more physical devices, and to propagate user settings stored in a physical device to multiple templates, including a master template that serves as the central repository for all of a user's settings.

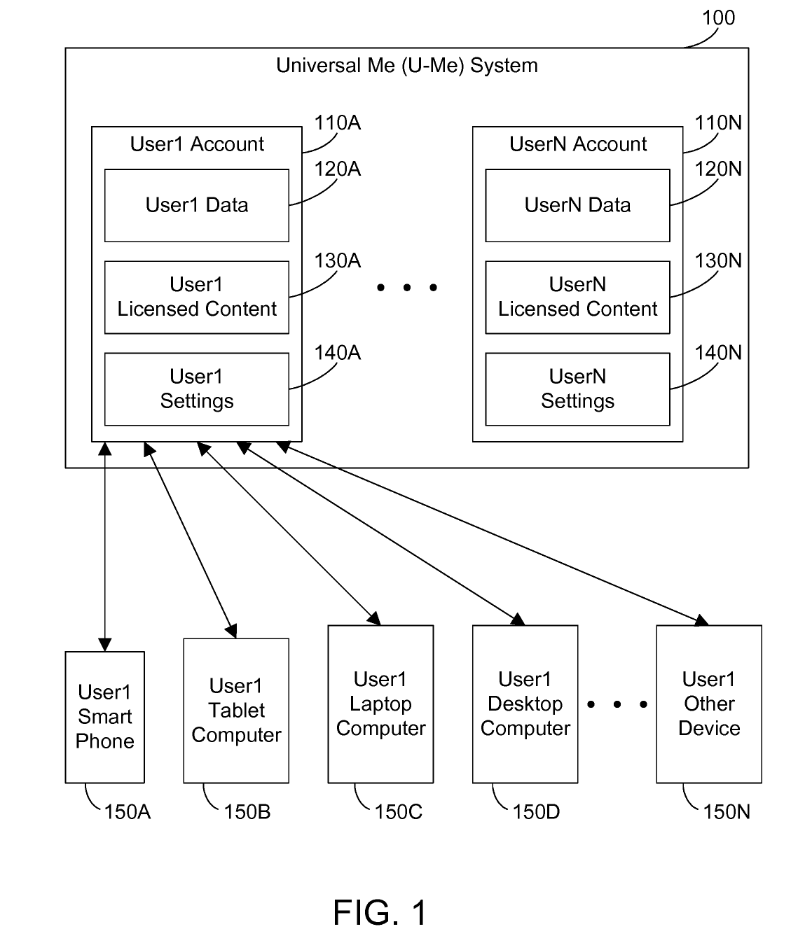

Referring to FIG. 1, the Universal Me (U-Me) system 100 includes multiple user accounts 110, shown in FIG. 1 as 110A, . . . , 110N. Each user account includes data, licensed content, and settings that correspond to the user. Thus, User1 account 110A includes corresponding data 120A, licensed content 130A, and settings 140A. In similar fashion, UserN account 110N includes corresponding data 120N, licensed content 130N, and settings 140N. Any or all of the user's data, licensed content and settings may be made available on any device 150 the user may use. Examples of suitable devices are shown in FIG. 1 to include a smart phone 150A, a tablet computer 150B, a laptop computer 150C, a desktop computer 150D, and other device 150N. The devices shown in FIG. 1 are examples of suitable devices the user could use to access any of the data, licensed content, or settings in the user's account. The disclosure and claims herein expressly extend to using any type of device to access the user's data, licensed content, or settings, whether the device is currently known or developed in the future.

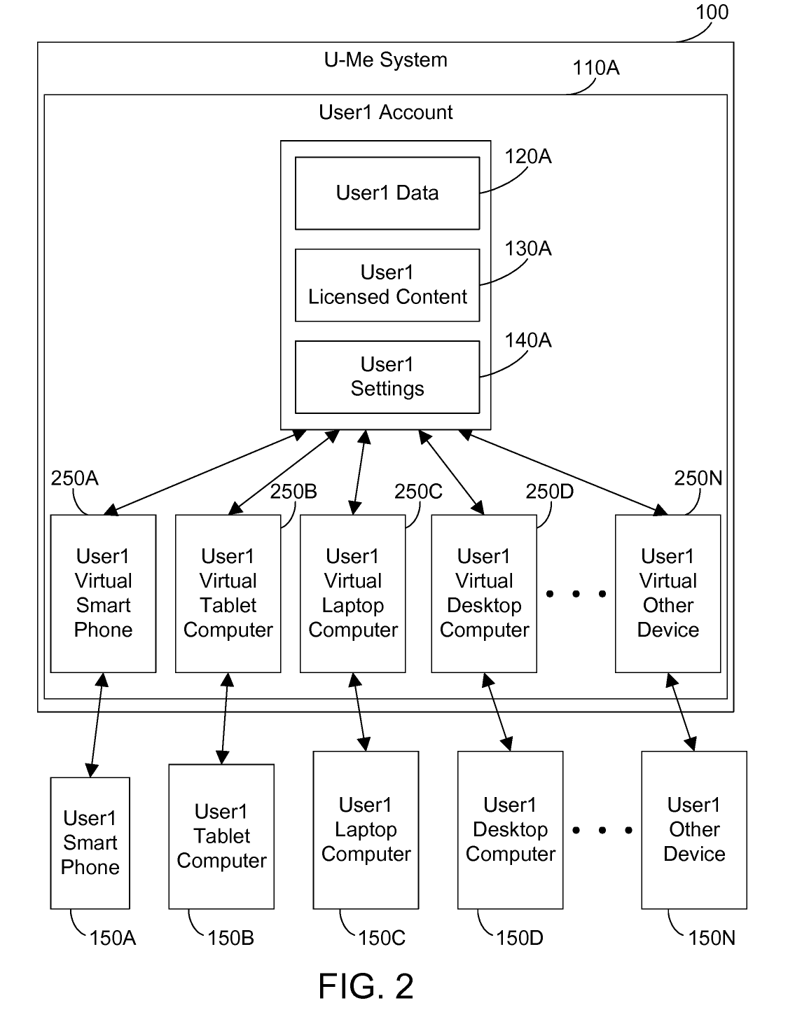

The U-Me system 100 may include virtual devices in a user's account. Referring to FIG. 2, the User1 account 110A is shown to include a virtual smart phone 250A that corresponds to the physical smart phone 150A; a virtual tablet computer 250B that corresponds to the physical tablet computer 150B; a virtual laptop computer 250C that corresponds to the physical laptop computer 150C; a virtual desktop computer 250D that corresponds to a physical desktop computer 150D; and a virtual other device 250N that corresponds to a physical other device 150N. The virtual devices preferably include all information that makes a physical device function, including operating system software and settings, software applications (including apps) and their settings, and user settings. It may be impossible due to access limitations on the physical device to copy all the information that makes the physical device function. For example, the operating system may not allow for the operating system code to be copied. The virtual devices contain as much information as they are allowed to contain by the physical devices. In the most preferred implementation, the virtual devices contain all information that makes the physical devices function. In this scenario, if a user accidentally flushes his smart phone down the toilet, the user can purchase a new smart phone, and all the needed information to configure the new smart phone exactly as the old one is available in the virtual smart phone stored in the user's U-Me account. Once the user downloads a U-Me app on the new smart phone, the phone will connect to the user's U-Me account, authenticate the user, and the user will then have the option of configuring the new device exactly as the old device was configured using the information in the virtual smart phone in the user's U-Me account.

There may be some software on a physical device that cannot be copied to the corresponding virtual device. When this is the case, the U-Me account will prompt the user with a list of things to do before the new physical device can be configured using the data in the virtual device. For example, if the user had just applied an operating system update and the new phone did not include that update, the user will be prompted to update the operating system before continuing. If an app installed on the old phone cannot be copied to the user's U-Me account, the U-Me app could prompt the user to install the app before the rest of the phone can be configured. The virtual device preferably contains as much information as possible for configuring the new device, but when information is missing, the U-Me system prompts the user to perform certain tasks as prerequisites. Once the tasks have been performed by the user, the U-Me system can take over and configure the phone using the information stored in the corresponding virtual device.

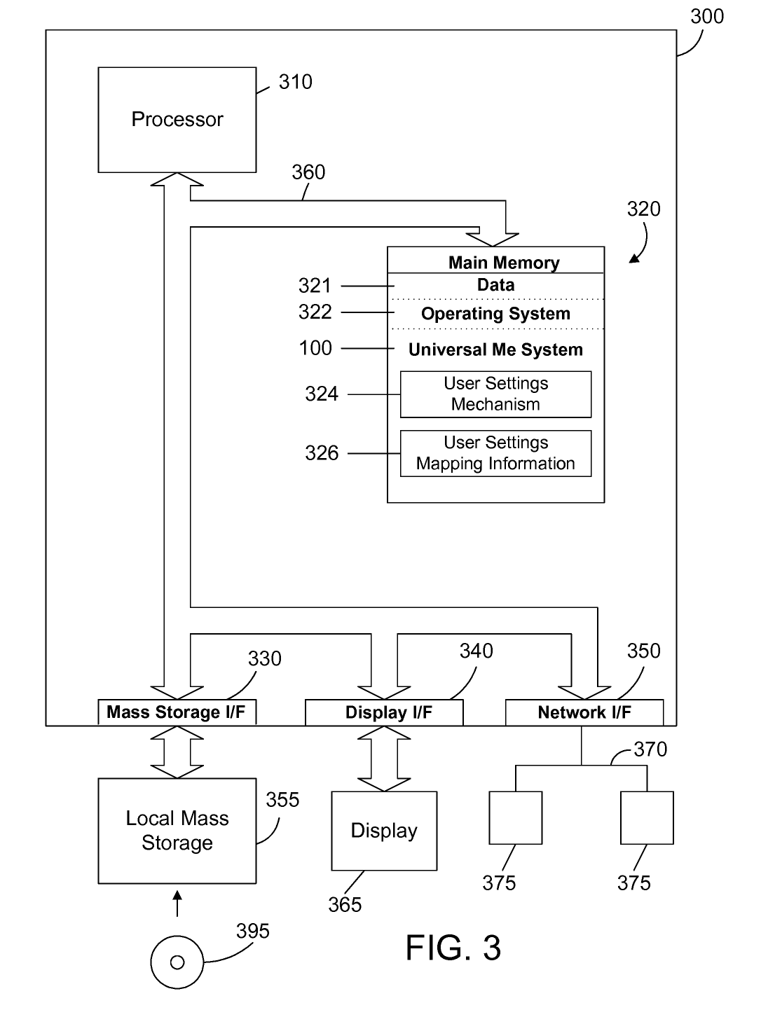

Referring to FIG. 3, a computer system 300 is an example of one suitable computer system that could host the universal me system 100. Server computer system 300 could be, for example, an IBM System i computer system. However, those skilled in the art will appreciate that the disclosure and claims herein apply equally to any computer system, regardless of whether the computer system is a complicated multi-user computing apparatus, a single user workstation, or an embedded control system. As shown in FIG. 3, computer system 300 comprises one or more processors 310, a main memory 320, a mass storage interface 330, a display interface 340, and a network interface 350. These system components are interconnected through the use of a system bus 360. Mass storage interface 330 is used to connect mass storage devices, such as local mass storage device 355, to computer system 300. One specific type of local mass storage device 355 is a readable and writable CD-RW drive, which may store data to and read data from a CD-RW 395.

Main memory 320 preferably contains data 321, an operating system 322, and the Universal Me System 100. Data 121 represents any data that serves as input to or output from any program in computer system 100. Operating system 322 is a multitasking operating system. The Universal Me System 100 is the cloud-based system described in detail in this specification, and includes a user settings mechanism 324 and user settings mapping information 326. The Universal Me System 100 as shown in FIG. 3 is a software mechanism that provides all of the functionality of the U-Me system.

Computer system 300 utilizes well known virtual addressing mechanisms that allow the programs of computer system 300 to behave as if they only have access to a large, contiguous address space instead of access to multiple, smaller storage entities such as main memory 320 and local mass storage device 355. Therefore, while data 321, operating system 322, and Universal Me System 100 are shown to reside in main memory 320, those skilled in the art will recognize that these items are not necessarily all completely contained in main memory 320 at the same time. It should also be noted that the term “memory” is used herein generically to refer to the entire virtual memory of computer system 300, and may include the virtual memory of other computer systems coupled to computer system 300.

Processor 310 may be constructed from one or more microprocessors and/or integrated circuits. Processor 310 executes program instructions stored in main memory 320. Main memory 320 stores programs and data that processor 310 may access. When computer system 300 starts up, processor 310 initially executes the program instructions that make up the operating system 322. Processor 310 also executes the Universal Me System 100.

Although computer system 300 is shown to contain only a single processor and a single system bus, those skilled in the art will appreciate that the universal me system may be practiced using a computer system that has multiple processors and/or multiple buses. In addition, the interfaces that are used preferably each include separate, fully programmed microprocessors that are used to off-load compute-intensive processing from processor 310. However, those skilled in the art will appreciate that these functions may be performed using I/O adapters as well.

Display interface 340 is used to directly connect one or more displays 365 to computer system 300. These displays 365, which may be non-intelligent (i.e., dumb) terminals or fully programmable workstations, are used to provide system administrators and users the ability to communicate with computer system 300. Note, however, that while display interface 340 is provided to support communication with one or more displays 365, computer system 300 does not necessarily require a display 365, because all needed interaction with users and other processes may occur via network interface 350.

Network interface 350 is used to connect computer system 300 to other computer systems or workstations 375 via network 370. Network interface 350 broadly represents any suitable way to interconnect electronic devices, regardless of whether the network 370 comprises present-day analog and/or digital techniques or via some networking mechanism of the future. Network interface 350 preferably includes a combination of hardware and software that allow communicating on the network 370. Software in the network interface 350 preferably includes a communication manager that manages communication with other computer systems 375 via network 370 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 350.

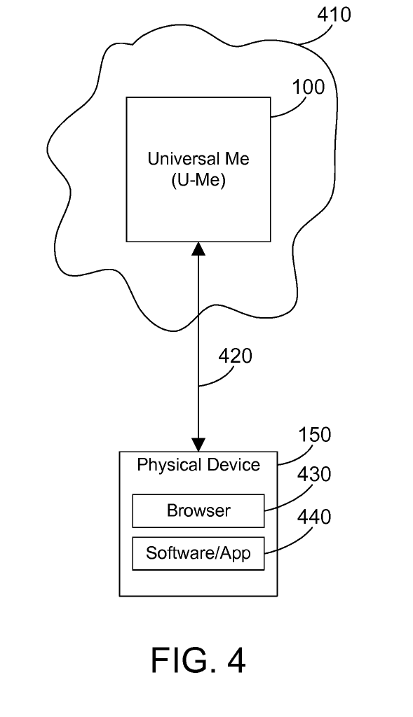

FIG. 4 shows another view of a configuration for running the U-Me system 100. The U-Me system 100 runs in a cloud, shown in FIG. 4 as cloud 410. A user connects to the U-Me system 100 using some physical device 150 that may include a browser 430 and/or software 440 (such as an application or app) that allows the user to interact with the U-Me system 100. Note the physical device 150 is connected to the U-Me system 100 by a network connection 420, which is representative of network 370 shown in FIG. 3, and which can include any suitable wired or wireless network or combination of networks. The network connection 420 in the most preferred implementation is an Internet connection, which makes the U-Me system available to any physical device that has Internet access. Note, however, other types of networks may be used, such as satellite networks and wireless networks. The disclosure and claims herein expressly extend to any suitable network or connection for connecting a physical device to the U-Me system 100.

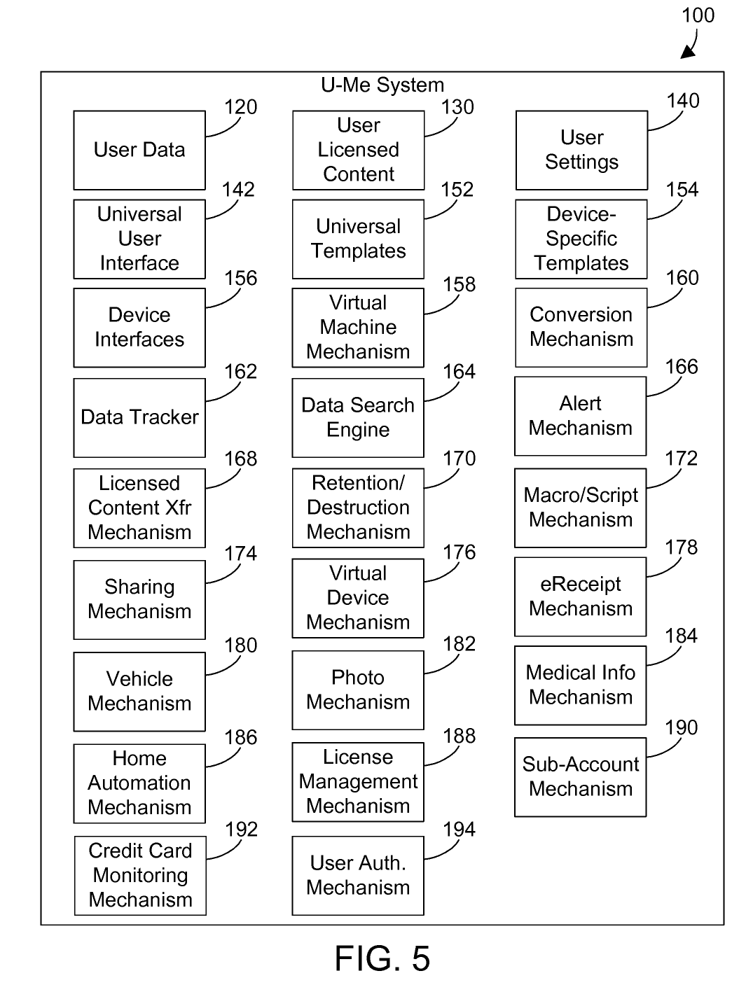

Various features of the U-Me system are represented in FIG. 5. U-Me system 100 includes user data 120, user licensed content 130, and user settings 140, as the specific examples in FIGS. 1 and 2 illustrate. U-Me system 100 further includes a universal user interface 142, universal templates 152, device-specific templates 154, device interfaces 156, a virtual machine mechanism 158, a conversion mechanism 160, a data tracker 162, a data search engine 164, an alert mechanism 166, a licensed content transfer mechanism 168, a retention/destruction mechanism 170, a macro/script mechanism 172, a sharing mechanism 174, a virtual device mechanism 176, an eReceipt mechanism 178, a vehicle mechanism 180, a photo mechanism 182, a medical info mechanism 184, a home automation mechanism 186, a license management mechanism 188, a sub-account mechanism 190, a credit card monitoring mechanism 192, and a user authentication mechanism 194. Some of these features are discussed in more detail below. The virtual devices 150 in FIG. 2 are preferably created and maintained by the virtual device mechanism 176 in FIG. 5.

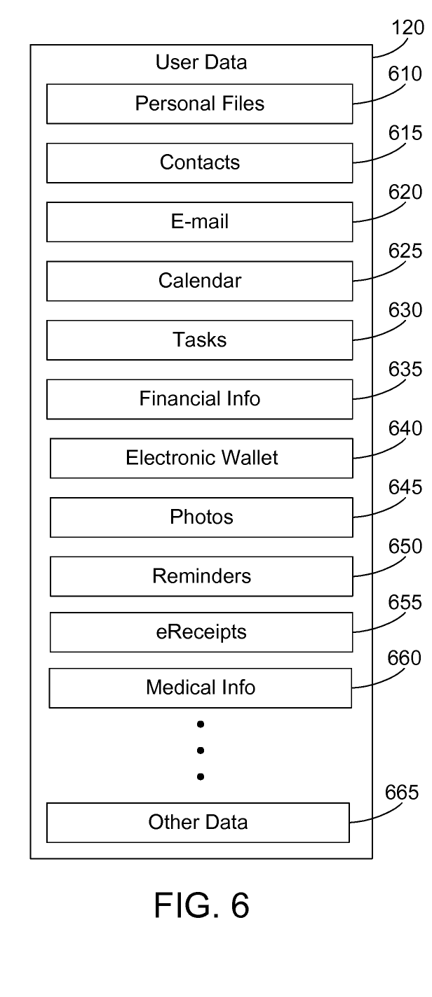

FIG. 6 shows some specific examples of user data 120 that could be stored in a user's U-Me account, including personal files 610, contacts 615, e-mail 620, calendar 625, tasks 630, financial info 635, an electronic wallet 640, photos 645, reminders 650, eReceipts 655, medical information 660, and other data 665. The user data shown in FIG. 6 are examples shown for the purpose of illustration. The disclosure and claims herein extend to any suitable data that can be generated by a user, generated for a user, or any other data relating in any way to the user, including data known today as well as data developed in the future.

Personal files 610 can include any files generated by the user, including word processor files, spreadsheet files, .pdf files, e-mail attachments, etc. Contacts 615 include information for a user's contacts, preferably including name, address, phone number(s), e-mail address, etc. E-mail 620 is e-mail for the user. E-mail 620 may include e-mail from a single e-mail account, or e-mail from multiple e-mail accounts. E-mail 620 may aggregate e-mails from different sources, or may separate e-mails from different sources into different categories or views. Calendar 625 includes an electronic calendar in any suitable form and format. Tasks 620 include tasks that a user may set and tasks set by the U-Me system. Financial info 625 can include any financial information relating to the user, including bank statements, tax returns, investment account information, etc. Electronic wallet 640 includes information for making electronic payments, including credit card and bank account information for the user. Google has a product for Android devices called Google Wallet. The electronic wallet 640 can include the features of known products such as Google Wallet, as well as other features not known in the art.

Photos 645 include electronic files for photographs and videos. While it is understood that a user may have videos that are separate from photographs, the term “photos” as used herein includes both photographs and videos for the sake of convenience in discussing the function of the U-Me system. Reminders 650 include any suitable reminders for the user, including reminders for events on the calendar 625, reminders for tasks 630, and reminders set by the U-Me system for other items or events. eReceipts 655 includes electronic receipts in the form of electronic files that may include warranty information and/or links that allow a user to make a warranty claim. Medical info 660 includes any suitable medical information relating to the user, including semi-private medical information, private medical information, and information provided by medical service providers, insurance companies, etc.

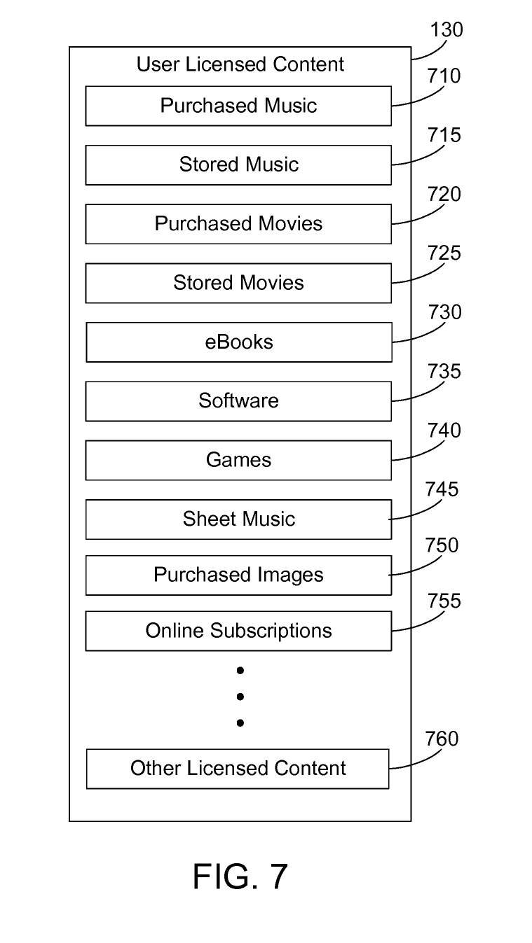

FIG. 7 shows some specific examples of user licensed content 130 that could be stored in a user's U-Me account, including purchased music 710, stored music 715, purchased movies 720, stored movies 725, eBooks 730, software 735, games 740, sheet music 745, purchased images 750, online subscriptions 755, and other licensed content 760. The user licensed content shown in FIG. 7 are examples shown for the purpose of illustration. The disclosure and claims herein extend to any suitable user licensed content, including user licensed content known today as well as user licensed content developed in the future.

Purchased music 710 includes music that was purchased from an online source. Note the purchased music 710 could include entire music files, or could include license information that authorizes the user to stream a music file on-demand. Stored music 715 includes music the user owns and which has been put into electronic format, such as music recorded (i.e., ripped) from a compact disc. Purchased movies 720 include movies that were purchased from an online source. Note the purchased movies 720 could include an entire movie file, or could include license information that authorizes the user to stream a movie on-demand. Stored movies 725 include movies the user owns and which have been put into electronic format, such as movies recorded from a digital video disc (DVD). eBooks 730 include books for the Apple iPad, books for the Kindle Fire, and books for the Barnes & Noble Nook. Of course, eBooks 730 could include books in any suitable electronic format.

Software 735 includes software licensed to the user and/or to the user's devices. In the most preferred implementation, software is licensed to the user and not to any particular device, which makes the software available to the user on any device capable of running the software. However, software 735 may also include software licensed to a user for use on only one device, as discussed in more detail below. Software 735 may include operating system software, software applications, apps, or any other software capable of running on any device. In addition, software 735 may include a backup of all software stored on all devices used by the user. Games 740 include any suitable electronic games, including games for computer systems and any suitable gaming system. Known gaming systems include Sony Playstation, Microsoft Xbox, Nintendo Wii, and others. Games 740 may include any games for any platform, whether currently known or developed in the future. Sheet music 745 includes sheet music that has been purchased by a user and is in electronic form. This may include sheet music files that are downloaded as well as hard copy sheet music that has been scanned. Some pianos now include an electronic display screen that is capable of displaying documents such as sheet music files. If a user owns such a piano, the user could access via the piano all of the user's stored sheet music 745 in the user's U-Me account. Purchased images 750 include any images purchased by the user, including clip art, pictures, etc. Online subscriptions 755 include content generated by the user on a subscription basis by any suitable provider. For example, if a user subscribes to Time magazine online, the online subscriptions 755 could include electronic copies of Time magazine.

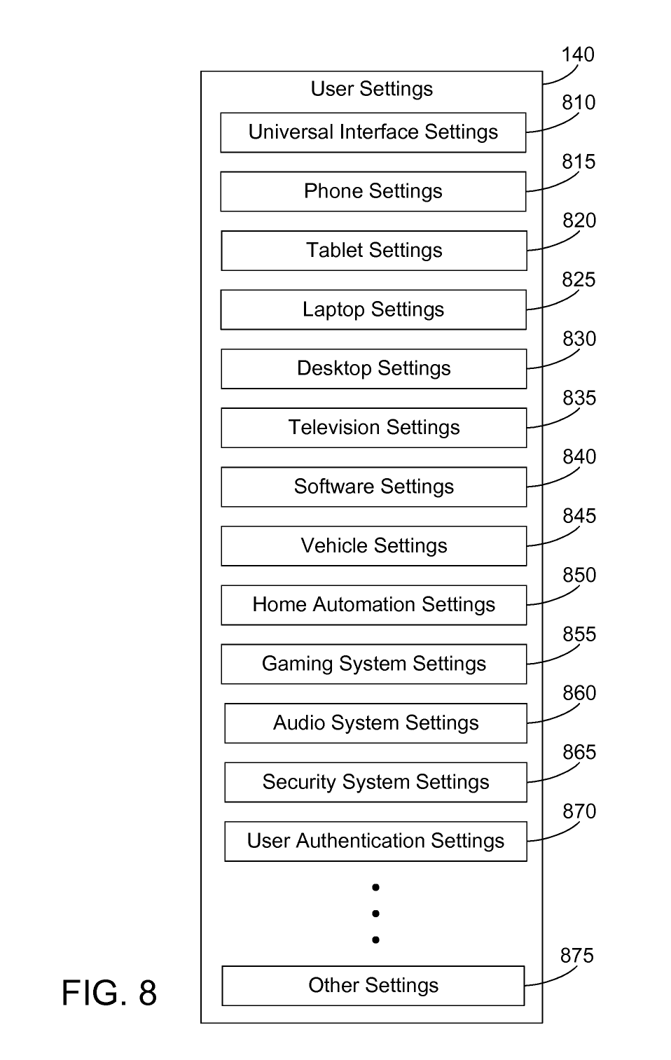

FIG. 8 shows some specific examples of user settings 140 that could be stored in a user's U-Me account, including universal interface settings 810, phone settings 815, tablet settings 820, laptop settings 825, desktop settings 830, television settings 835, software settings 840, vehicle settings 845, home automation settings 850, gaming system settings 855, audio system settings 860, security system settings 865, user authentication settings 870, and other settings 875. The user settings shown in FIG. 8 are examples shown for the purpose of illustration. The software settings 840, which include user settings for software applications, include user preferences for each software application. Note the term “software application” is used herein to broadly encompass any software the user can use, whether it is operating system software, an application for a desktop, an app for a phone, or any other type of software. User settings for physical devices include user settings for each physical device. The term “physical device” is used herein to broadly any tangible device, whether currently known or developed in the future, that includes any combination of hardware and software. The disclosure and claims herein extend to any suitable user settings, including user settings known today as well as user settings developed in the future.

Universal interface settings 810 include settings for a universal interface for the U-Me system that can be presented to a user on any suitable device, which allows the user to interact with the U-Me system using that device. Phone settings 815 include settings for the user's phone, such as a smart phone. Apple iPhone and Samsung Galaxy S4 are examples of known smart phones. Tablet settings 820 include settings for the user's tablet computer. Examples of known tablet computers include the Apple iPad, Amazon Kindle, Barnes & Noble Nook, Samsung Galaxy Tab, and many others. Laptop settings 825 are settings for a laptop computer. Desktop settings 830 are settings for a desktop computer. Television settings 835 are settings for any suitable television device. For example, television settings 835 could include settings for a television, for a cable set-top box, for a satellite digital video recorder (DVR), for a remote control, and for many other television devices. Software settings 840 include settings specific to software used by the user. Examples of software settings include the configuration of a customizable menu bar on a graphics program such as Microsoft Visio; bookmarks in Google Chrome or favorites in Internet Explorer; default file directory for a word processor such as Microsoft Word; etc. Software settings 840 may include any suitable settings for software that may be defined or configured by a user.

Vehicle settings 845 include user settings relating to a vehicle, including such things as position of seats, position of mirrors, position of the steering wheel, radio presets, heat/cool settings, music playlists, and video playlists. Home automation settings 850 include settings for a home automation system, and may include settings for appliances, heating/ventilation/air conditioning (HVAC), lights, security, home theater, etc. Gaming system settings 855 include settings relating to any gaming system. Audio system settings 860 include settings for any suitable audio system, including a vehicle audio system, a home theater system, a handheld audio player, etc. The security system settings 865 may include settings for any suitable security system. User authentication settings 870 include settings related to the user's authentication to the U-Me system.

The U-Me system makes a user's data, licensed content, and settings available to the user on any device the user desires to use. This is a significant advantage for many reasons. First of all, even for people who are comfortable with technology, getting a device configured exactly as the user wants is time-consuming and often requires research to figure out how to configure the device. For example, let's assume a user installs the Google Chrome browser on a desktop computer. When the user downloads a file using Google Chrome, the downloaded file appears as a clickable icon on the lower left of the Google Chrome display. To open the file, the user clicks on the icon. Let's assume the user wants to always open .pdf files after they are downloaded. Because the user does not know how to configure Chrome to do this, the user does a quick search, and discovers that Chrome can be configured to always open .pdf files after they are downloaded by clicking on a down arrow next to the downloaded .pdf file icon, which brings up a pop-up menu, then selecting “Always open files of this type.” This configures Google Chrome to always open .pdf files after they are downloaded. However, the user cannot be expected to remember this small tidbit of knowledge. If the user made this setting change to Google Chrome when the desktop computer was new, and two years passes when the user gets a new desktop computer, it is highly unlikely the user will remember how to configure Google Chrome to automatically open .pdf files after they are downloaded. In any modern device, there are dozens or perhaps hundreds of such user settings. By storing these user settings in the user's U-Me account, the user will not have to remember each and every setting the user makes in each and every device. The same is true for configuring a smart phone. Often users have to search online to figure out how to do certain things, such as setting different ringtones for different contacts. In today's world, such settings are lost when a user changes to a different phone, which requires the user repeat the learning process to configure the new phone. With the U-Me system disclosed herein, all of the user's settings are saved to the user's U-Me account, allowing a new device to be easily configured using the stored user settings.

While the previous paragraph discusses an example of a user setting in Google Chrome, similar concepts apply to user data and user licensed content. There is currently no known way to make all of a user's data, licensed content, and settings available in the cloud so this information is available to the user on any device or system the user decides to use. The Universal Me system solves this problem. The system is called Universal Me because it allows “me to be me, anywhere” for each user. Thus, a user on vacation on Italy could find an Internet café, use a computer in the Internet café to access the user's universal interface to the U-Me system, and would then have access to all of the user's data, licensed content, and settings. Similarly, the user could borrow an iPad from a friend, and have access to all the user's data, licensed content, and settings. The power and flexibility of the U-Me system leads to its usage in many different scenarios, several of which are described in detail below.

While many different categories of user settings are shown in FIG. 8, these are shown by way of example. A benefit of the U-Me system is that a user only has to configure a device once, and the configuration for that device is stored in the user's U-Me account. Replacing a device that is lost, stolen, or broken is a simple matter of buying a new similar device, then following the instructions provided by the U-Me system to configure the new device to be identical to the old device. In the most preferred implementation, the U-Me system will back up all user data, licensed content, and settings related to the device to the user's U-Me account, which will allow the U-Me system to configure the new device automatically with minimal input from the user. However, features of the devices themselves may prevent copying all the relevant data, licensed content and settings to the user's U-Me account. When this is the case, the U-Me system will provide instructions to the user regarding what steps the user needs to take before the U-Me system can configure the device with the information stored in the user's U-Me account.

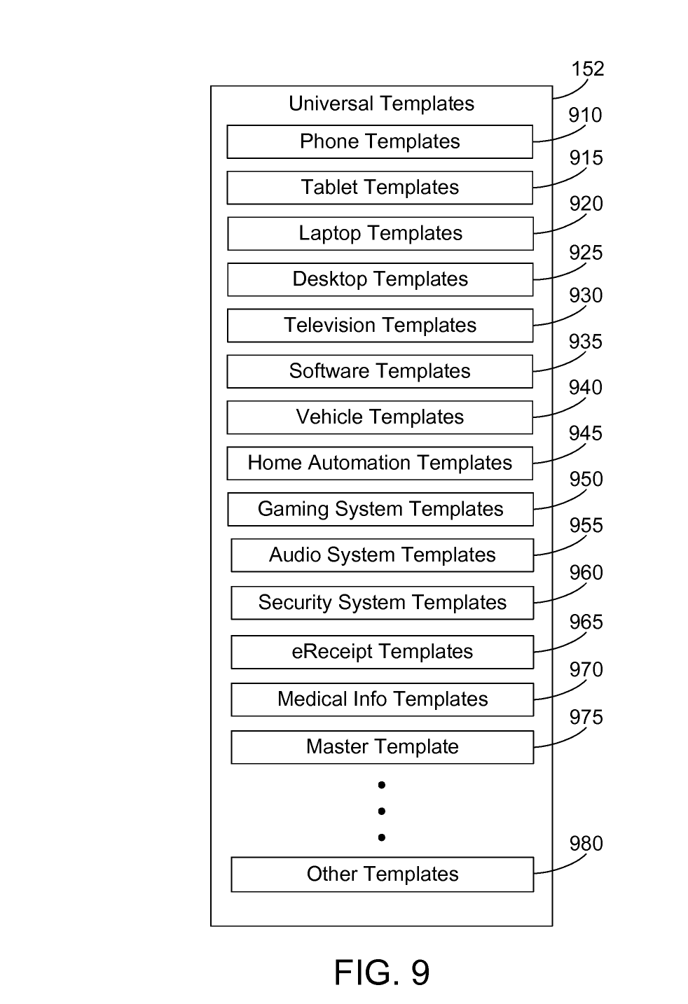

The U-Me system could use various templates that define settings for different physical devices. Referring to FIG. 9, universal templates 152 include phone templates 910, tablet templates 915, laptop templates 920, desktop templates 925, television templates 930, software templates 935, vehicle templates 940, home automation templates 945, gaming system templates 950, audio system templates 955, security system templates 960, eReceipt templates 965, medical information templates 970, a master template 975, and other templates 980. The universal templates shown in FIG. 9 are examples shown for the purpose of illustration. The disclosure and claims herein extend to any suitable universal templates, including universal templates related to devices known today as well as universal templates related to devices developed in the future.

The various universal templates in FIG. 9 include categories of devices that may include user settings. One of the benefits of the U-Me system is the ability for a user to store settings for any device or type of device that requires configuration by the user. This allows a user to spend time once to configure a device or type of device, and the stored settings in the user's U-Me account will allow automatically configuring identical or similar devices. The U-Me system expressly extends to storing any suitable user data and/or user licensed content and/or user settings for any suitable device in a user's U-Me account.

The universal templates 152 provide a platform-independent way of defining settings for a particular type of device. Thus, a universal phone template may be defined by a user using the U-Me system without regard to which particular phone the user currently has or plans to acquire. Because the universal templates are platform-independent, they may include settings that do not directly map to a specific physical device. Note, however, the universal templates may include information uploaded from one or more physical devices. The universal template can thus become a superset of user data, user licensed content, and user settings for multiple devices. The universal templates can also include settings that do not correspond to a particular setting on a particular device.

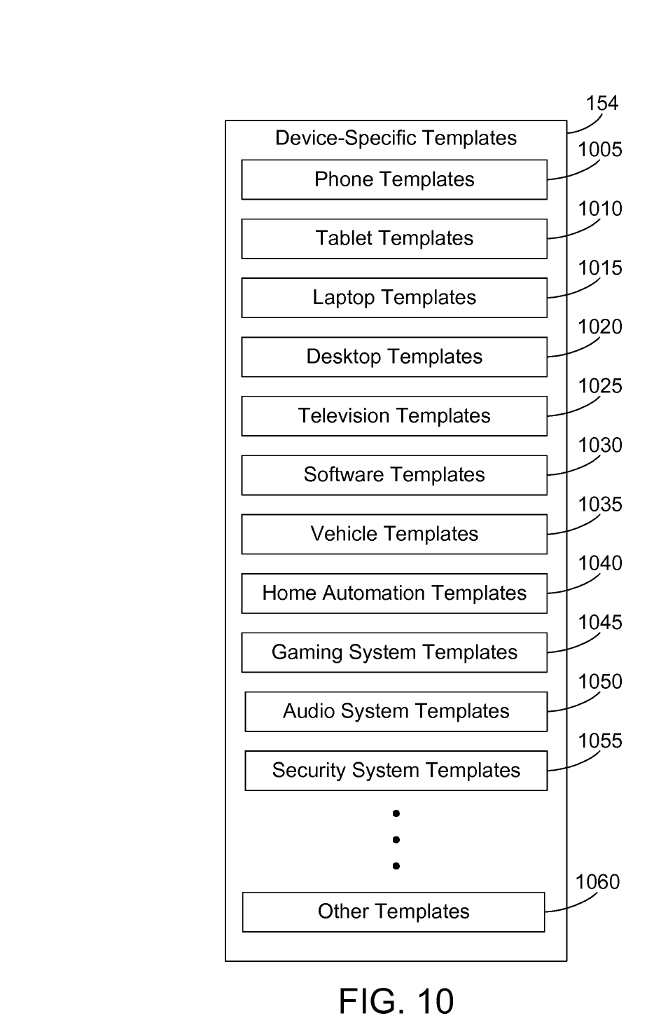

Referring to FIG. 10, device-specific templates 154 include phone templates 1005, tablet templates 1010, laptop templates 1015, desktop templates 1020, television templates 1025, software templates 1030, vehicle templates 1035, home automation templates 1040, gaming system templates 1045, audio system templates 1050, security system templates 1055, and other templates 1060. The device-specific templates shown in FIG. 10 are examples shown for the purpose of illustration. The disclosure and claims herein extend to any suitable device-specific templates, including device-specific templates for devices known today as well as device-specific templates for devices developed in the future.

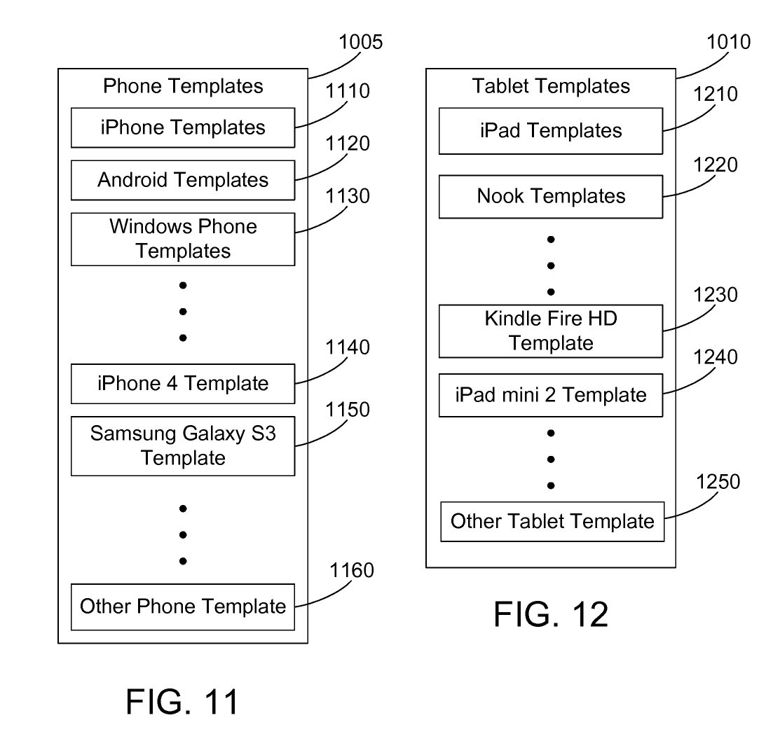

The device-specific templates 154 provide platform-dependent templates. Thus, the user data, user licensed content, and user settings represented in a device-specific template includes specific items on a specific device or device type. The device-specific templates 154 may also include mapping information to map settings in a physical device to settings in a universal template. FIGS. 11-21 are related to device specific templates 154. Referring to FIG. 11, phone templates 1005 may include iPhone templates 1110, Android templates 1120 and Windows phone templates 1130, which represent different phone types. Phone templates 1005 may also include templates for a specific phone, such as iPhone 4 template 1140 and Samsung Galaxy S3 template 1150, as well as one or more other phone templates 1160 that may be for a phone type or for a specific phone.

Tablet templates 1010 are shown in FIG. 12 to include iPad templates 1210 and Nook templates 1220, which represent different tablet platforms. Tablet templates 1010 may also include templates for a specific tablet, such as a Kindle Fire HD template 1230 and an iPad mini 2 template 1240, as well as one or more other tablet templates 1250 that may be for a tablet type or for a specific tablet.

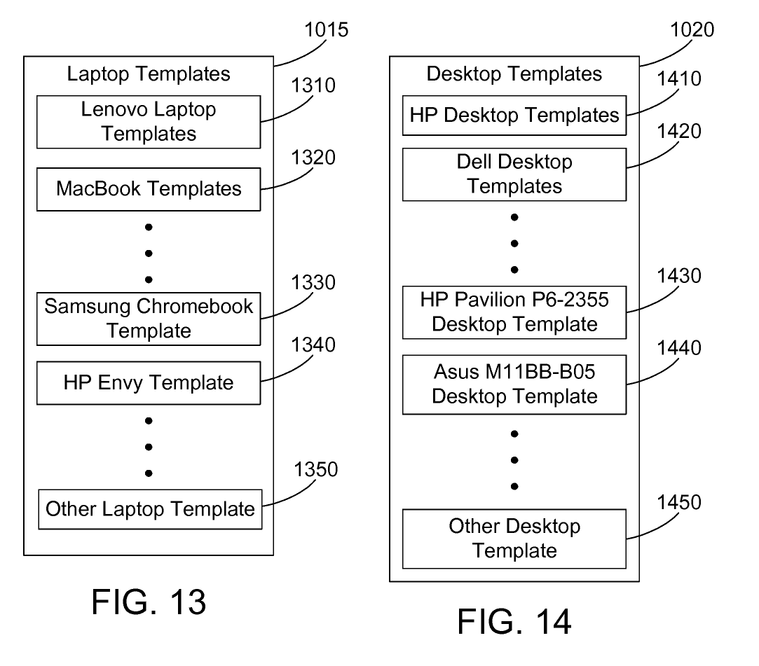

Laptop templates 1015 are shown in FIG. 13 to include Lenovo laptop templates 1310 and MacBook templates 1320, which represent different laptop computer types. Laptop templates 1015 may also include templates for a specific laptop, such as a Samsung Chromebook template 1330 and an HP Envy template 1340, as well as one or more other laptop templates 1350 that may be for a laptop type or for a specific laptop.

Desktop templates 1020 are shown in FIG. 14 to include HP desktop templates 1410 and Dell desktop templates 1420, which represent different laptop computer types. Desktop templates 1020 may also include templates for a specific desktop computer, such as an HP Pavilion PS-2355 desktop template 1430 and an Asus M11BB-B05 desktop template 1440, as well as one or more other desktop templates 1450 that may be for a desktop type or for a specific desktop computer.

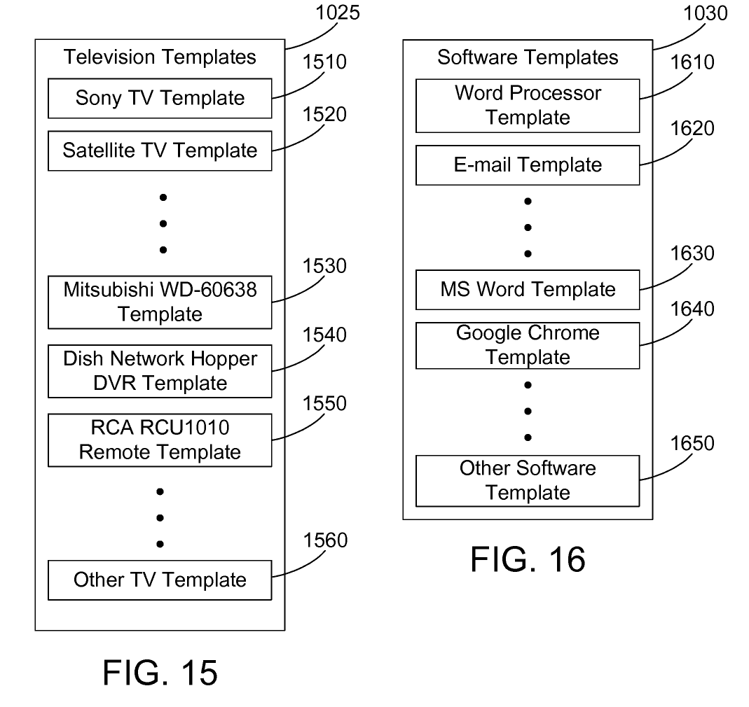

Television templates 1025 are shown in FIG. 15 to include a Sony TV template 1510 and a satellite TV template 1520, which represent different types of television devices. Television templates 1025 may also include templates for a specific television device, such as a Mitsubishi WD-60638 template 1530, a Dish Network Hopper DVR template 1540, and an RCA RCU1010 remote template 1540, as well as one or more other television device templates 1560 that may be for a television device type or for a specific television-related device.

Software templates 1030 are shown in FIG. 16 to include a word processor template 1610 and an e-mail template 1620, which represent different types of software. Software templates 1030 may also include templates for specific software, such as a Microsoft Word template 1630 and a Google Chrome template 1640, as well as one or more other software templates 1650 that may be for a type of software or for specific software.

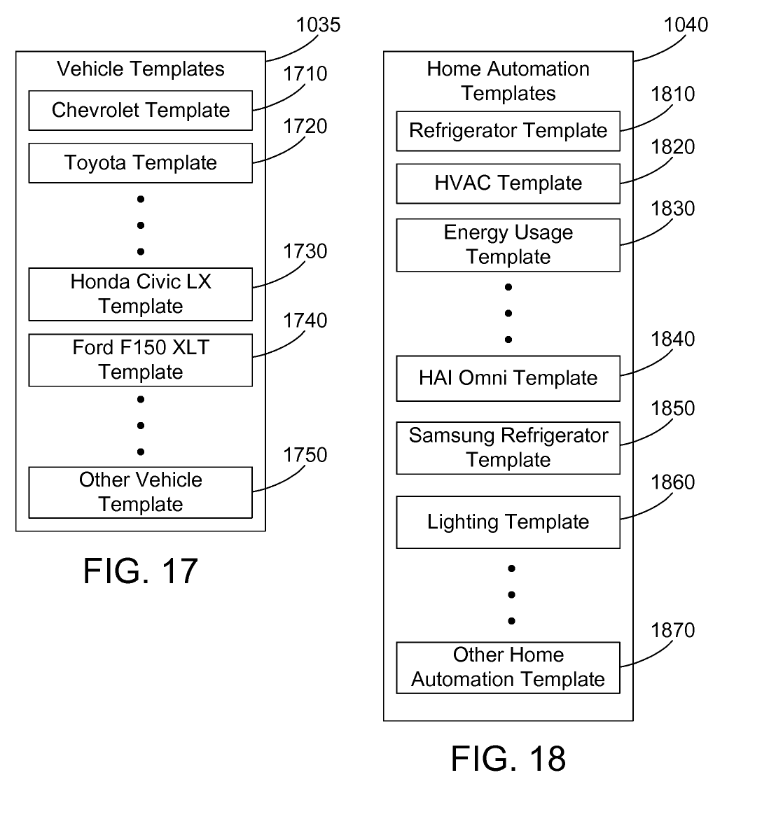

Vehicle templates 1035 are shown in FIG. 17 to include a Chevrolet template 1710 and a Toyota template 1720, which represent different types of vehicles. Vehicle templates 1035 may also include templates for specific vehicles, such as a Honda Civic LX template 1730 or a Ford F150 XLT template 1740, as well as one or more other vehicle templates 1750 that may be for a type of vehicle or for a specific vehicle. Note while the only vehicles shown in FIG. 17 are cars and a small truck, the vehicle templates 1035 could include templates for any type of vehicle, including cars, trucks, boats, large semi trucks, planes, and other vehicles.

Home automation templates 1040 are shown in FIG. 18 to include a refrigerator template 1810, an HVAC template 1820, and an energy usage template 1830, which represent different things that may be controlled by a home automation system. Home automation templates 1040 may also include templates for specific home automation systems, such as Home Automation Inc. (HAI) Omni template 1840, Samsung refrigerator template 1850, lighting template 1860, as well as one or more other home automation templates 1870 that may be for a type of home automation controller or type of item controlled by a home automation controller or for a specific home automation controller or item controlled by a home automation controller.

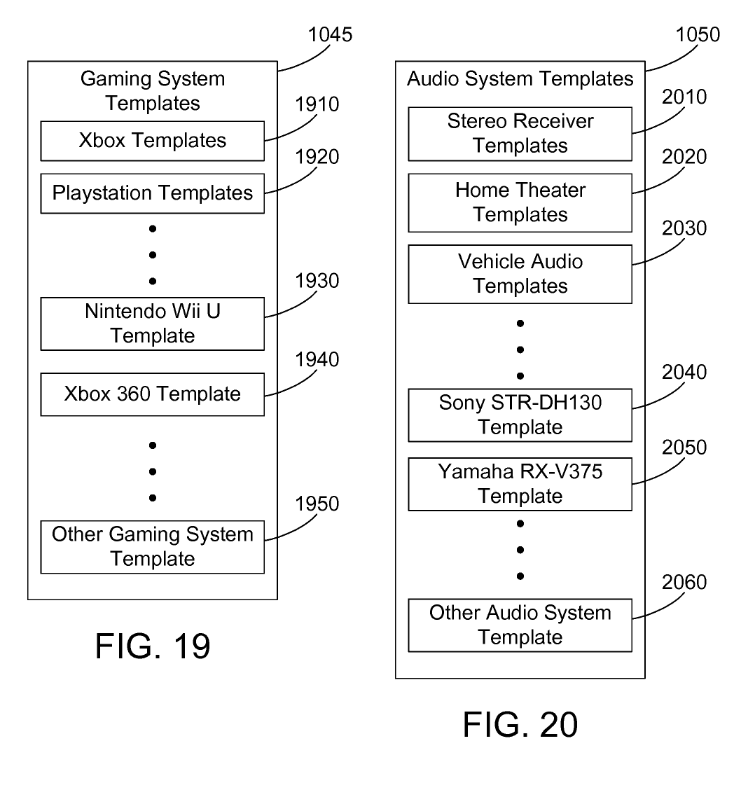

Gaming system templates 1045 are shown in FIG. 19 to include Xbox templates 1910 and Playstation templates, which represent different types of gaming systems. Gaming templates 1045 may also include templates for specific gaming systems, such as Nintendo Wii U template 1930 and Xbox 360 template 1940, as well as one or more other gaming system templates 1950 that may be for a type of gaming system or for a specific gaming system.

Audio system templates 1050 are shown in FIG. 20 to include stereo receiver templates 2010, home theater templates 2020, and vehicle audio templates 2030, which represent different types of audio systems. Audio system templates 1050 may also include templates for specific audio systems, such as Sony STR-DH130 template 2040 and Yamaha RX-V375 template 2050, as well as one or more other audio system templates 2060 that may be for a type of audio system or for a specific audio system.

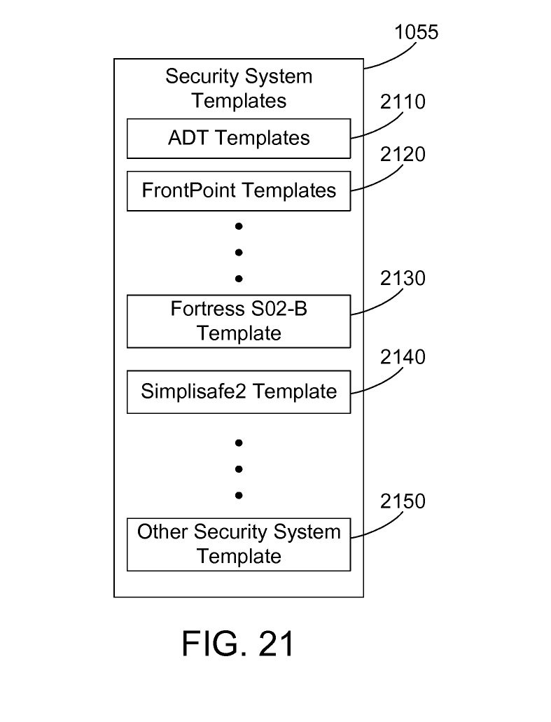

Security system templates 1055 are shown in FIG. 21 to include ADT templates 2110 and FrontPoint templates 2120, which represent different types of security systems from different manufacturers. Security system templates 1055 may also include templates for specific security systems, such as a Fortress SO2-B template 2130 and a Simplisafe2 template 2140, as well as one or more other security system templates 2150 that may be for a type of security system or for a specific audio system.

While the templates disclosed herein may be of any suitable format, it is expected that industry experts will have to spend time brainstorming and meeting to arrive at an industry standard. Thus, the automotive industry may generate an industry-standard template for cars, while the personal computer industry may generate a very different industry-standard template for desktop computers. Generating and publishing standard templates will greatly accelerate the acceptance of the U-Me system.

The device-specific templates shown in FIGS. 10-21 could be provided by any suitable entity. For example, the U-Me system may provide some of the device-specific templates. However, some device-specific templates will preferably be provided by manufacturers of devices. As discussed below, the U-Me system includes the capability of device manufacturers to become “U-Me Certified”, which means their devices have been designed and certified to appropriately interact with the U-Me system. Part of the U-Me certification process for a device manufacturer could be for the manufacturer to provide a universal template for each category of devices the manufacturer produces, a device-specific template for each category of devices the manufacturer produces, as well as a device-specific template for each specific device the manufacturer sells.

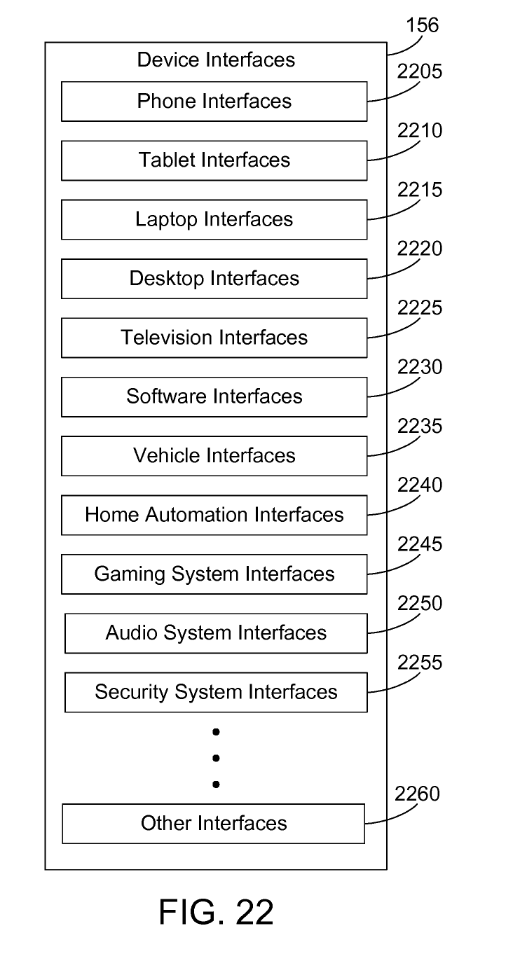

Referring to FIG. 22, device interfaces 156 preferably include phone interfaces 2205, tablet interfaces 2210, laptop interfaces 2215, desktop interfaces 2220, television interfaces 2225, software interfaces 2230, vehicle interfaces 2235, home automation interfaces 2240, gaming system interfaces 2245, audio system interfaces 2250, security system interfaces 2255, and other interfaces 2260. The device interfaces shown in FIG. 22 are examples shown for the purpose of illustration. The disclosure and claims herein extend to any suitable device interfaces, including device interfaces for devices known today as well as device interfaces for devices developed in the future.

Each device interface provides the logic and intelligence to interact with a specific type of device or with a specific device. Thus, phone interfaces 2205 could include an iPhone interface and an Android interface. In addition, phone interfaces 2205 could include different interfaces for the same type of device. Thus, phone interfaces 2205 could include separate phone interfaces for an iPhone 4 and an iPhone 5. In the alternative, phone interfaces 2205 could be combined into a single phone interface that has the logic and intelligence to communicate with any phone. In the most preferred implementation, a device interface is provided for each specific device that will interact with the U-Me system. This could be a requirement for a device to become U-Me certified, that the manufacturer of the device provide the device interface that meets U-Me specifications.

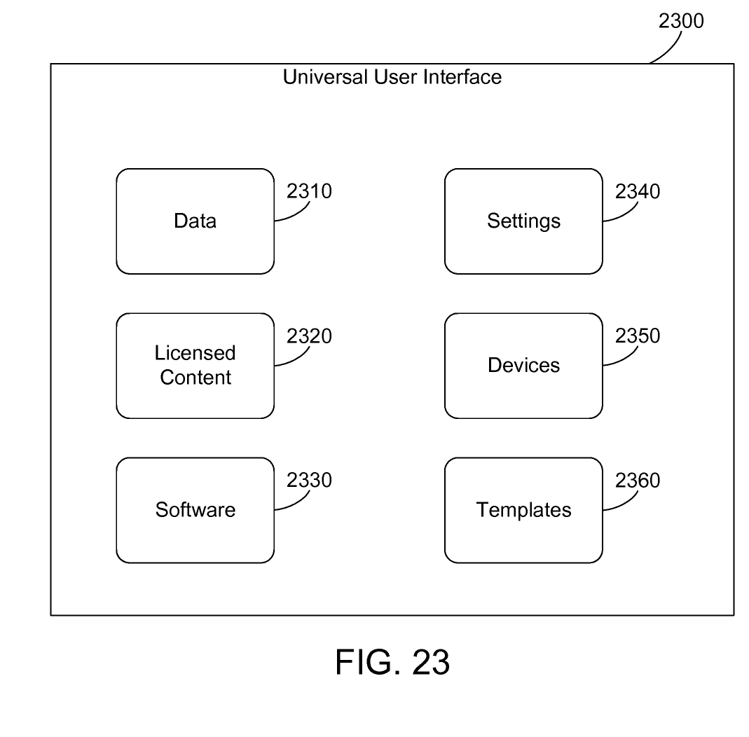

The U-Me system preferably includes a universal user interface 142 shown in FIG. 5. The universal user interface 2300 shown in FIG. 23 is one suitable example of a specific implementation for the universal user interface 142 shown in FIG. 5. The universal user interface 2300 in FIG. 23 includes several icons the user may select to access various features in the U-Me system. The icons shown in FIG. 23 include a data icon 2310, a licensed content icon 2320, a software icon 2330, a settings icon 2340, a devices icon 2350, and a templates icon 2360. Selecting the data icon 2310 gives the user access to the user data 120 stored in the user's U-Me account, including the types of data shown in FIG. 6. One way for the user to access the user data 120 is via a data search engine. Selecting the licensed content icon 2320 gives the user access to any and all of the user's licensed content 130, including the categories of licensed content shown in FIG. 7. Selecting the software icon 2330 gives the user access to software available in the user's U-Me account. While software is technically a category of licensed content (see 735 in FIG. 7), a separate icon 2330 is provided in the universal user interface 2300 in FIG. 23 because most users would not mentally know to select the licensed content icon 2320 to run software. Selecting the software icon 2330 results in a display of the various software applications available in the user's U-Me account. The user may then select one of the software applications to run. The display of software icons could be considered a “virtual desktop” that is available anywhere via a browser or other suitable interface.

Selecting the settings icon 2340 gives the user access to any and all of the user settings 140, including the categories of settings shown in FIG. 8. Selecting the devices icon 2350 gives the user access to virtual devices, which are discussed in more detail below, where the virtual devices correspond to a physical device used by the user. The user will also have access to the device interfaces 156, including the device interfaces shown in FIG. 22. Accessing devices via the device interfaces allows the user to have remote control via the universal user interface over different physical devices. Selecting the templates icon 2360 gives the user access to the templates in the user's U-Me account, including: universal templates, including the universal templates shown in FIG. 9; and device-specific templates, including the device-specific templates shown in FIGS. 10-21. The devices icon 2350 and the templates icon 2360 provide access to information in the user's U-Me account pertaining to devices and templates, which can be part of the settings in the user's U-Me account. While the Devices icon 2350 and Templates icon 2360 could be displayed as a result of a user selecting the Setting icon 2240, these icons 2350 and 2360 that are separate from the settings icon 2340 are provided in FIG. 23 to make using the universal user interface 2300 more intuitive for the user.

The universal user interface gives the user great flexibility in accessing a user's U-Me account. In the most preferred implementation, the universal user interface is browser-based, which means it can be accessed on any device that has a web browser. Of course, other configurations for the universal user interface are also possible, and are within the scope of the disclosure and claims herein. For example, a user on vacation in a foreign country can go into an Internet café, invoke the login page for the U-Me system, log in, and select an icon that causes the universal user interface (e.g., 2300 in FIG. 23) to be displayed. The user then has access to any and all information stored in the user's U-Me account.

Because the universal user interface allows a user to access the user's U-Me account on any device, the universal user interface also provides a way for a user to change settings on the user's devices. Because the user's U-Me account includes virtual devices that mirror the configuration of their physical device counterparts, the user could use a laptop or desktop computer to define the settings for the user's phone. This can be a significant advantage, particularly for those who don't see well or who are not dexterous enough to use the tiny keypads on a phone. A simple example will illustrate. Let's assume a U-Me user wants to assign a specific ringtone to her husband's contact info in her phone. The user could sit down at a desktop computer, access the universal user interface 2300, select the Devices icon 2350, select a Phone icon, which then gives the user access to all of the settings in the phone. The user can then navigate a menu displayed on a desktop computer system using a mouse and full-sized keyboard to change settings on the phone instead of touching tiny links and typing on a tiny keyboard provided by the phone. The user could assign the ringtone to her husband's contact info in the settings in the virtual device in the U-Me account that corresponds to her phone. Once she makes the change in the virtual phone settings in the U-Me account, this change will be automatically propagated to her phone. The universal user interface may thus provide access to the user to set or change the settings for all of the user's physical devices.

The universal user interface 142 can include any suitable interface type. In fact, the universal user interface 142 can provide different levels of interfaces depending on preferences set by the user. Thus, the universal user interface may provide simple, intermediate, and power interfaces that vary in how the information is presented to the user depending on the user's preferences, which could reflect the technical prowess and capability of the user. Those who are the least comfortable with technology could select a simple interface, which could provide wizards and lots of help context to help a user accomplish a desired task. Those more comfortable with technology could select the intermediate interface, which provides fewer wizards and less help, but allows a user to more directly interact with and control the U-Me system. And those who are very technically-oriented can select the power interface, which provides few wizards or help, but allows the user to directly interact with and control many aspects of the U-Me system in a powerful way.

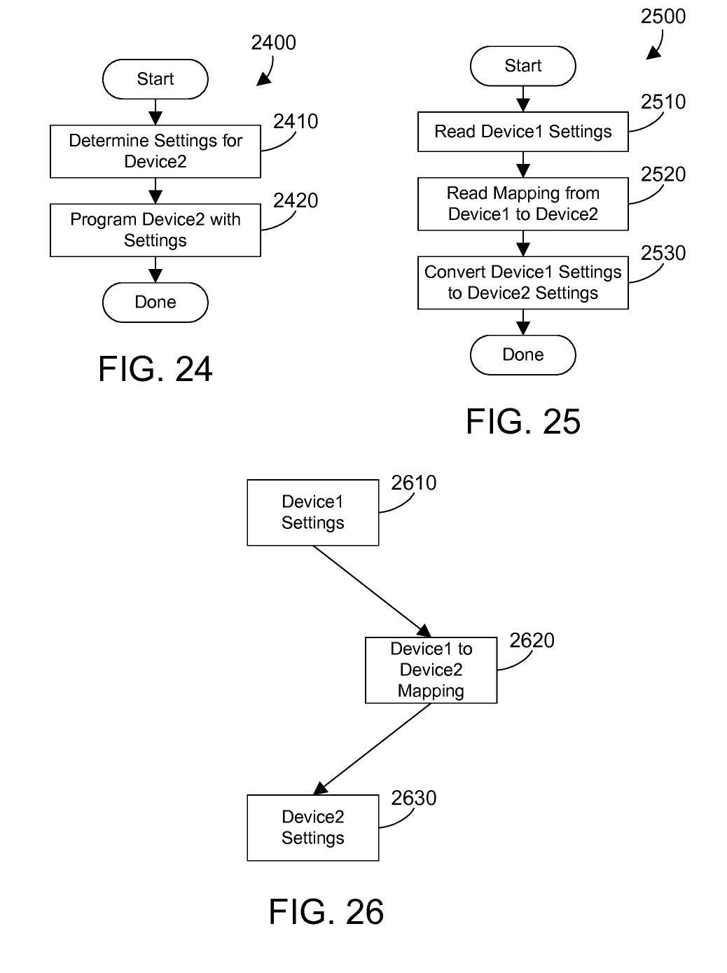

There are many different ways to program a device using the information in the user's U-Me account. Referring to FIG. 24, a method 2400 for programming a device called Device2 begins by determining settings for Device2 (step 2410), then programming the device with those settings (step 2420). There are different ways to determine the settings for Device2 in step 2410. Referring to FIG. 25, method 2500 shows one suitable implementation for step 2410 in FIG. 24. Settings for a device called Device1 are read (step 2510). A mapping from Device1 to Device2 is then read (step 2520). The settings for Device1 are then converted to the settings for Device2 (step 2530). This is shown graphically in FIG. 26, where the Device1 settings 2610 are converted using the Device1 to Device2 mapping 2620 to Device2 settings 2630. This first example in FIGS. 25 and 26 show how to program a device by converting settings from one device to settings for a different device. For example, let's assume a user has been using an iPhone 4, then decides to change to a Samsung Galaxy S4 phone. Assuming there are device-specific templates 154 for both phones, the conversion mechanism 160 in FIG. 5 can convert the settings on the iPhone 4 to settings on the Samsung Galaxy S4, provided there is a mapping in the phone templates between the device-specific settings of the two devices. The example in FIGS. 25 and 26 shows how to program a device by converting from settings of a different device.

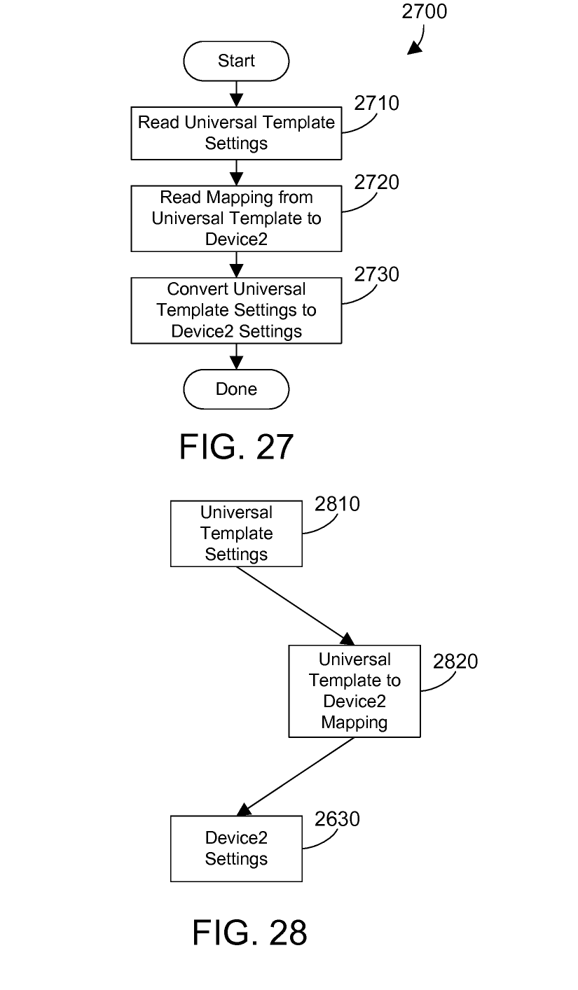

A second suitable implementation for step 2410 in FIG. 24 is shown in FIGS. 27 and 28. In this implementation, Device2 is programmed from settings stored in the Universal Template corresponding to Device2. The universal template settings are read (step 2710). A mapping from the universal template to Device 2 is read (step 2720). The conversion mechanism then converts the settings from the universal template to the settings for Device2 (step 2730). This is shown graphically in FIG. 28, where universal template settings 2810 are converted using the universal template to Device2 mapping 2820 to generate Device2 settings 2630. This second implementation in FIGS. 27 and 28 vary from the first implementation in steps 25 and 26 because the conversion of settings is between the universal template settings to the Device2 settings, not from the settings of another device (such as Device1).

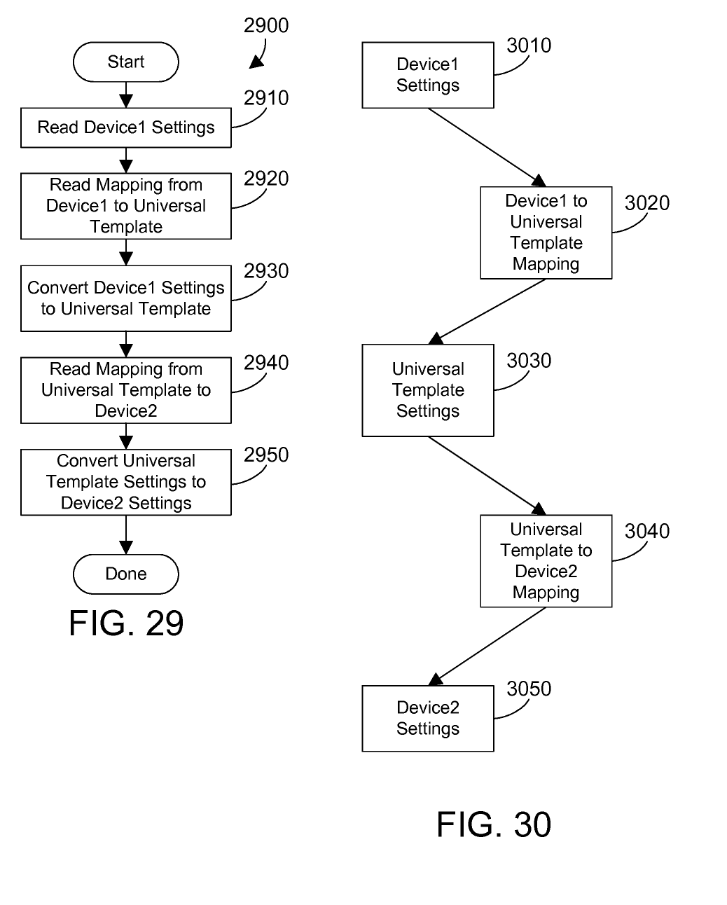

A third suitable implementation for step 2410 in FIG. 24 is shown in FIGS. 29 and 30. Device1 settings are read (step 2910). A mapping from Device1 to the universal template is also read (step 2920). The Device1 settings are then converted to the universal template settings (step 2930). A mapping from the universal template to Device2 is then read (step 2940). The universal template settings are then converted to Device 2 settings (step 2950). This is shown graphically in FIG. 30, where the Device1 settings are converted using the Device1 to universal template mapping 3020 to universal template settings 3030, which are then converted using the universal template to Device2 mapping 3040 to Device2 settings 3050. This third implementation converts settings between two devices, similar to the first implementation shown in FIGS. 25 and 26, but this is not a direct mapping between two devices, but is rather a mapping to and from universal template settings.

The conversion of settings from one device to another in FIGS. 25-30 can be performed by the conversion mechanism 160 shown in FIG. 5, which could include the user settings mechanism 324 and the user settings mapping information 326 shown in FIG. 3. The examples in FIGS. 25-30 allow converting settings from one device to corresponding settings for a different device. The different device may be of the same type or may be of a different type. Type can be defined according to hardware architecture, system software (e.g., operating system), manufacturer, brand, or any other characteristic that characterizes a device. Thus, an iPhone and a Samsung Galaxy phone are devices of different types because they have a different hardware architecture type and run different system software. A Chevrolet and a Toyota are devices of different types because they are made by different manufacturers. An iPhone 4 and iPhone5 could be categorized as devices of the same type because they have the same hardware architecture type and run the same system software, even if the version of the system software is not the exact same. The disclosure and claims herein extends to any suitable definition or categorization for the “type” of a device. The conversion mechanism allows converting settings between devices of the same type, between devices of similar type, and also between devices of different types. For example, devices may be of the same type when they have the same hardware architecture type and run the same system software. Devices may be of similar type when they have the same hardware architecture type and run different system software. Devices may be of different types when they have different hardware architecture type and different system software.

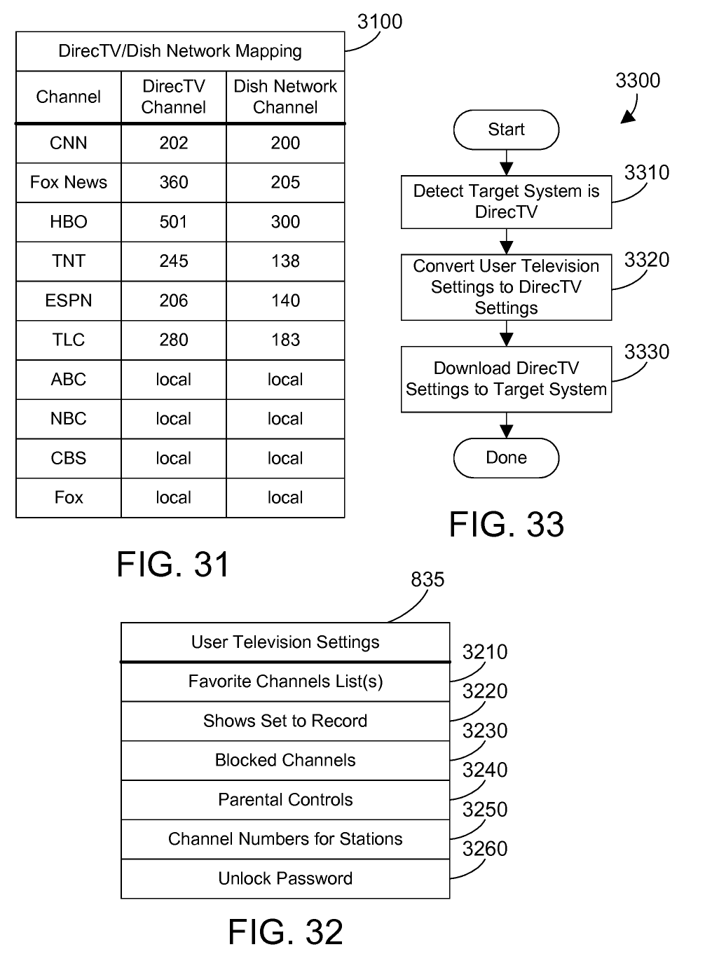

We now consider one specific usage of the U-Me system with regards to television equipment with respect to FIGS. 31-33. We assume a user's television settings are store in the user's U-Me account. Examples of suitable television settings 835 are shown in FIG. 32 to include one or more favorite channels list 3210, shows set to record 3220, blocked channels 3230, parental controls 3240, channel numbers for stations 3250, and an unlock password 3260. These are all settings the user can define, for example, in a DVR for Dish Network. For this specific example, we assume the user has Dish Network at the user's home, and programs the Dish Network DVR with some or all of the user television settings 835 shown in FIG. 32. We now assume the user travels to a new location during a vacation, such as a hotel room, a resort, a relative's house, etc., and we further assume the new location has DirecTV. Referring to FIG. 33, method 3300 begins by detecting the target system (at the new location) is a DirecTV system (step 3310). The user's Dish Network television settings are converted to equivalent or similar DirecTV settings in the user's U-Me account (step 3320). The converted DirecTV settings from the user's U-Me account are then downloaded to the DirecTV target system (e.g., DVR) at the new location (step 3330). The result is the user's Dish Network television settings are now available on the DirecTV DVR. One part of the conversion in step 3320 is converting the channel numbers from Dish Network to the equivalent channel numbers in DirecTV. A sample mapping for ten channels is shown at 3100 in FIG. 31. Note the channels ABC, NBC, CBS and Fox in the mapping 3100 show “local” instead of a number, because the channel numbers will vary from one geographic region to the next. The indication of “local” in the channel mapping will indicate a need to determine the location of the target system, and determine the appropriate mapping to the target system using the channel numbers that are specific to the geographic region where the target system is located. This is a task easily accomplished by the U-Me system. The mapping 3100 shown in FIG. 31 is one suitable example for user settings mapping information 326 shown in FIG. 3.

Note that known DVRs for Dish Network and DirecTV do not allow downloading settings as discussed above with respect to method 3300 in FIG. 33. For television providers to work in conjunction with the U-Me system, each provider's DVR will need to be “U-Me Certified”, meaning the DVR includes logic and intelligence that allows the DVR to interact with the U-Me system. This certification process will also preferably provide a device-specific template for each DVR, along with information that allows mapping the settings from one provider to another provider. In the most preferred implementation, a universal template for a DVR could be defined with required fields, and each device-specific template for each DVR will have to have the required fields specified in the universal DVR template.

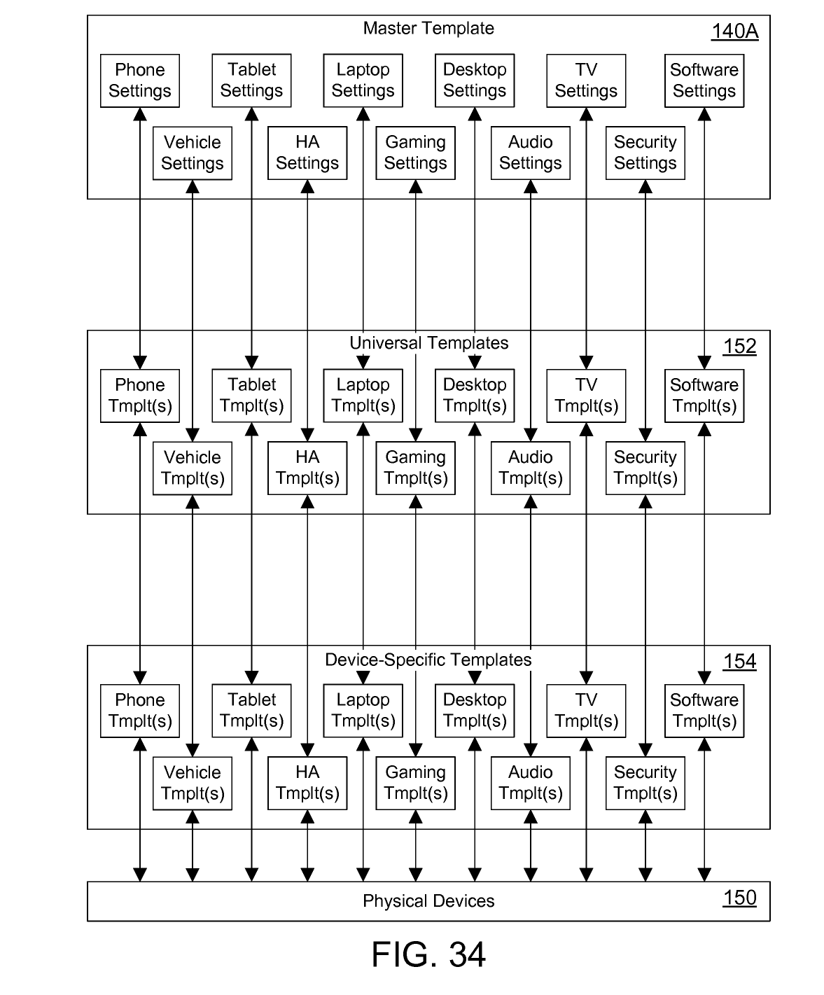

FIG. 34 shows a suitable hierarchy of templates related to physical devices. A master template 140A shown in FIG. 24 is one suitable implementation for user settings shown by way of example as 140A in FIGS. 1 and 2. The master template 140A in FIG. 34 could be one suitable implementation for master template 975 shown in FIG. 9. Master template 140A includes settings for multiple physical devices for one user. In one preferred implementation, the master template 140A is a superset that includes all settings for all of the user's devices, and thus serves as a central repository for storing all of a user's settings. In the most preferred implementation, the master template 140A includes settings from a single user. However, one of ordinary skill in the art will appreciate that the U-Me system could have a repository for settings from many different users, with a master template corresponding to each user.

As shown in FIG. 34, the master template 140A may include all of the user's settings, which may include, for example, phone settings, tablet settings, laptop settings, desktop settings, TV settings, software settings, vehicle settings, home automation settings, gaming settings, audio settings, and security settings. Because the U-Me system is intended to include any settings a user may have, the U-Me system could include settings for all of a user's devices, even those that are developed in the future. The master template 140A as shown in FIG. 34 may include any and all settings for a user.

The U-Me system may optionally include one or more universal templates 152 as discussed above with reference to FIGS. 5 and 9. The universal templates 152 may include, for example, one or more phone templates, one or more tablet templates, one or more laptop templates, one or more desktop templates, one or more TV templates, one or more software templates, one or more vehicle templates, one or more home automation templates, one or more gaming templates, one or more audio templates, and one or more security templates.

The U-Me system also includes one or more device-specific templates 154 as discussed above with reference to FIGS. 5 and 10-21. The device-specific templates 154 may include, for example, one or more phone templates, one or more tablet templates, one or more laptop templates, one or more desktop templates, one or more TV templates, one or more software templates, one or more vehicle templates, one or more home automation templates, one or more gaming templates, one or more audio templates, and one or more security templates, as shown in detail in FIGS. 10-21.

Physical devices 150 may include any suitable device the user may use, and which includes one or more user settings a user may set. Physical devices 150 may include, for example, one or more phones, one or more tablet computers, one or more laptop computers, one or more desktop computers, one or more TV devices, one or more vehicles, one or more home automation systems, one or more gaming systems, one or more audio systems, one or more security systems, and any other physical device a user may use.

As indicated by arrows in FIG. 34, settings in physical devices 150 are stored in corresponding device-specific templates 154, which serve as virtual clones of the physical device. The settings in the device-specific templates 154 may be stored in one or more universal templates 152. The settings in the universal templates 152 may be stored in the master template 140A. Note, however, the universal templates 152 are optional. The master template 140A may store settings directly to device-specific templates 154, and the device-specific templates 154 may store settings directly to the master template 140A. The universal templates 152, when used, provide a more organized hierarchy of templates that may help in the process of mapping user settings between templates and between templates and physical devices.

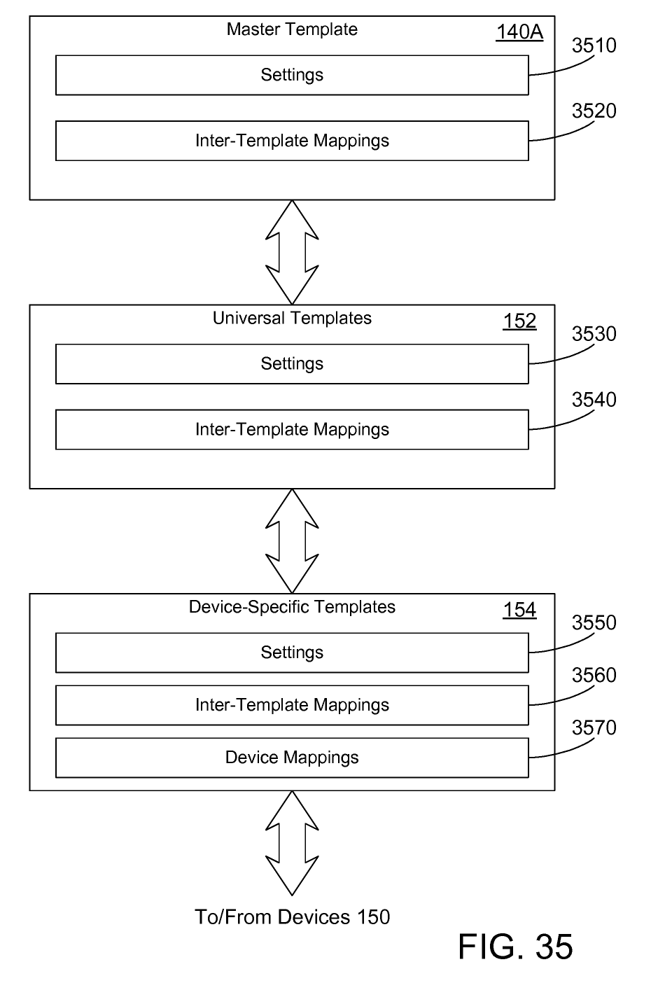

In one suitable implementation, each template includes mapping information to other templates or to a physical device. Referring to FIG. 35, device-specific templates 154 preferably include settings 3550 that correspond to settings in the physical devices 150, and additionally include inter-template mappings 3560 and device mappings 3570. Inter-template mappings 3560 indicate how the user settings 3550 map to corresponding settings in one or more other templates. Device mappings 3570 indicate how the settings 3550 map to the corresponding physical devices 150. In one specific implementation, device mappings 3570 may not be needed when the settings 3550 correspond exactly to the user settings on a physical device 150. In an alternative implementation, the device mappings 3570 may indicate how to map the user settings 3550 to the settings on a physical device 150.

Universal templates 152 may include settings 3530 and inter-template mappings 3540 that indicate how the settings 3530 are mapped to settings in other templates. Master template 140A includes settings 3510 and inter-template mappings 3520 that indicate how the settings 3510 are mapped to settings in other templates. In the specific example shown in FIG. 35, each template includes the mappings that map the user settings. Of course, other implementations are possible within the scope of the disclosure and claims herein. For example, the inter-template mappings 3520, 3540 and 3560, and the device mappings 3570, could be stored separately from the templates. The mappings 3520, 3540, 3560 and 3570 could all be part of the user settings mapping information 326 shown in FIG. 3.

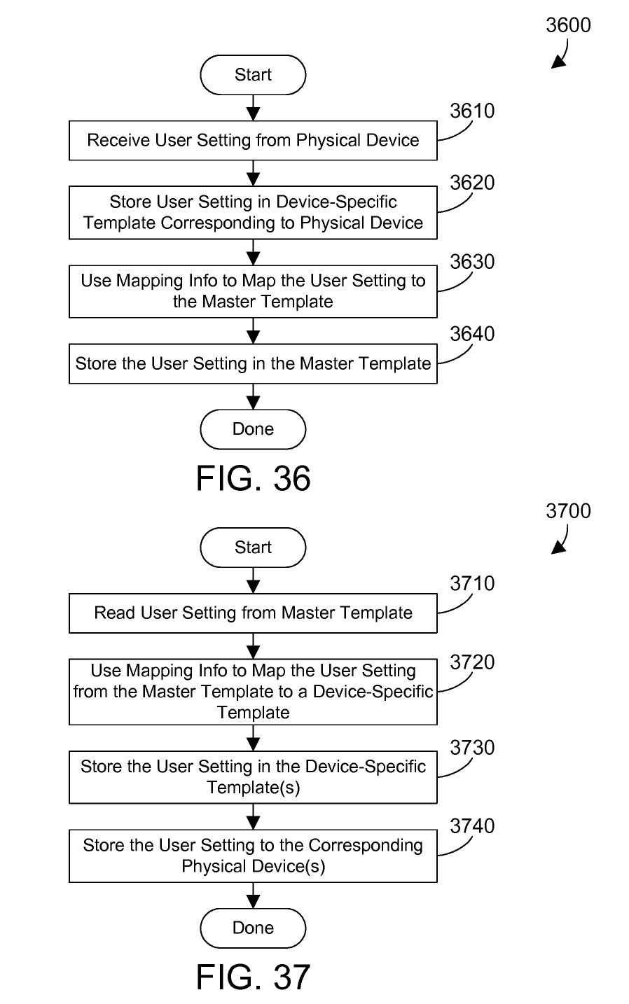

The hierarchy of templates shown in FIGS. 34 and 35 allow user settings to be stored to templates from physical devices, and to physical devices from templates by the user settings mechanism 324 shown in FIG. 3. Note the user settings mechanism 324 could be implemented within the conversion mechanism 160 shown in FIG. 5. Referring to FIG. 36, a method 3600 begins by receiving a user setting from a physical device (step 3610). This could happen, for example, when a user changes a setting on an existing physical device. The user setting is stored to the device-specific template corresponding to the physical device (step 3620). The mapping information is then used to map the user setting to the master template (step 3630). Note this may include mapping between multiple levels of universal templates to the master template. The user setting is then stored to the master template (step 3640). Method 36 illustrates how all user settings are stored both in a device-specific template as well as in the master template. The master template in the most preferred implementation thus becomes a superset of all user settings for all of a user's devices, and is thus a central repository for all of a user's settings.

FIG. 37 shows a method 3700 for storing a setting from a master template to a physical device. A user setting is read from the master template (step 3710). The mapping information is then used to map the user setting to a corresponding device-specific template (step 3720). The user setting is then mapped to one or more physical devices (step 3730). The user setting is then stored to the corresponding one or more physical devices (step 3740). Note that one setting in the master template may map to multiple physical devices. Thus, if the user changes the address for a contact, the changed address may be written to the user's phone, laptop computer and desktop computer using method 3700 shown in FIG. 37.

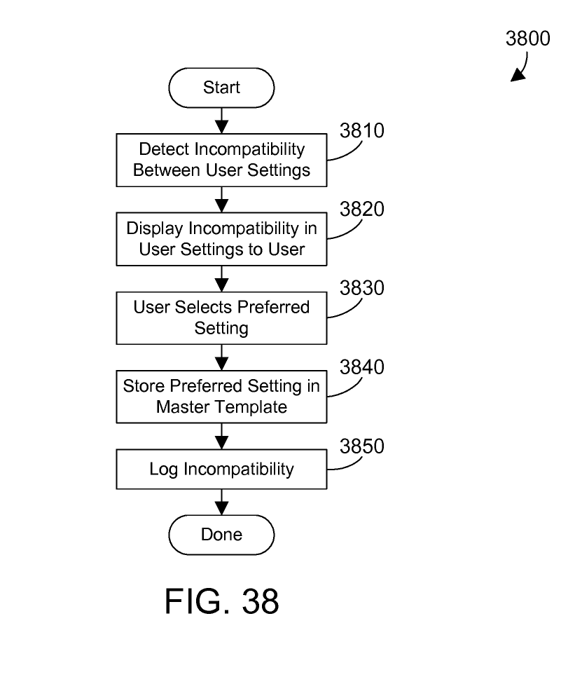

The user may have different settings on multiple devices that may create an incompatibility that needs to be resolved. Referring to FIG. 38, method 3800 begins when an incompatibility in user settings is detected (step 3810). The incompatibility in user settings is displayed to the user (step 3820). The user may then select the preferred setting (step 3830). The preferred setting is then stored in the master template (step 3840). The incompatibility is then logged (step 3850).

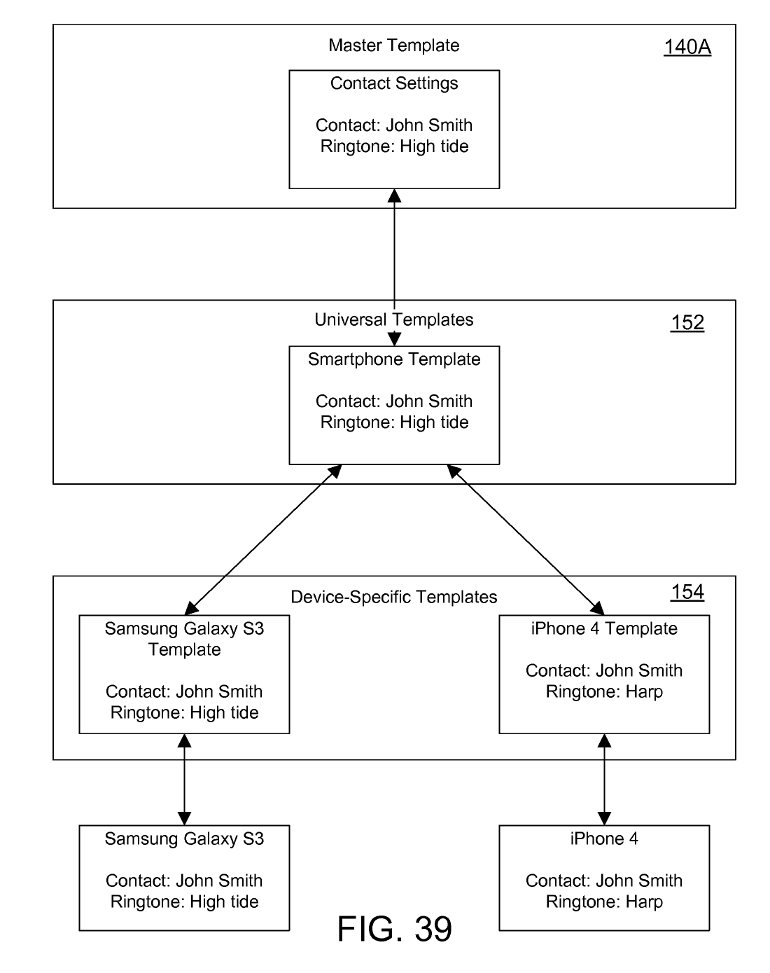

An example of incompatible settings is shown in FIG. 39. We assume the user has two phones, a Samsung Galaxy S3 and an Apple iPhone 4. The user has a contact John Smith that has a ringtone of High Tide on the Samsung Galaxy S3, while the same contact John Smith on the iPhone 4 has a ringtone of Harp. The device-specific templates 154 shown in FIG. 39 shows these settings in the respective corresponding physical devices. We assume the user is prompted with this incompatibility in step 3820 in FIG. 38, and selects the ringtone High Tide in step 3830 as the desired ringtone for the Universal Template 152. This setting is then stored in the master template in step 3840. While this simple example shows how to resolve an incompatibility, there may be reasons why an incompatibility cannot be resolved by the user. For example, if the Samsung Galaxy S3 phone does not have a ringtone called Harp, and if the iPhone 4 does not have a ringtone called High Tide, there will be no way to resolve the discrepancy between the two. Instead, both ringtones could be stored in the universal template and in the master template. The information logged in step 3850 may indicate to the U-Me system when settings are not compatible, and thus multiple settings for different devices should be stored.

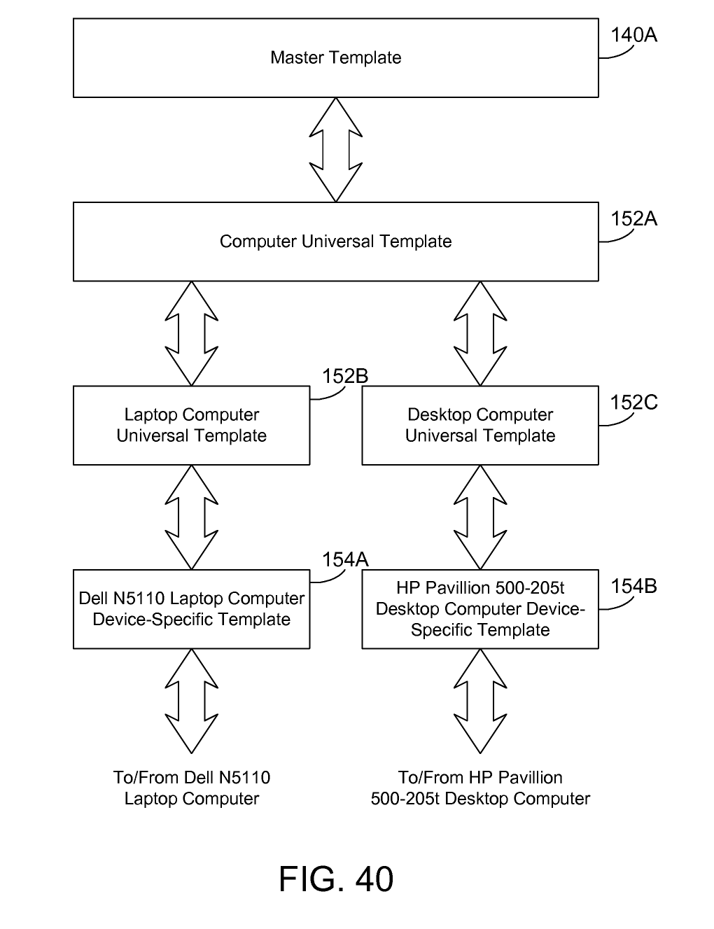

FIG. 40 illustrates that multiple levels of universal templates may be optionally employed between the device-specific templates and the master template. The settings from the master template 140A are mapped to and from a computer universal template 152A. The settings to and from the computer universal template 152A are mapped to and from a laptop computer universal template 152B and to and from a desktop computer universal template 152C. The settings in the laptop computer universal template 152B are mapped to and from a Dell N5110 laptop computer device-specific template 154A, which sends settings to and receives settings from a Dell N5110 laptop computer, thereby serving as a virtual clone of the Dell N5110 laptop computer. The settings in the desktop computer universal template 152C are mapped to and from a HP Pavillion 500-205t desktop computer device-specific template 154B, which sends settings to and receives settings from a HP Pavillion 500-205t desktop computer, thereby serving as a virtual clone of the HP Pavillion 500-205t desktop computer. Including multiple levels of universal templates allows creating a hierarchy of templates that ease the process of mapping between templates.

As will be appreciated by one skilled in the art, aspects of the U-Me system may be embodied as a system, method or computer program product. Accordingly, aspects of the U-Me system may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the U-Me system may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the U-Me system may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the U-Me system are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The figures and disclosure herein support an apparatus comprising: at least one processor; a memory coupled to the at least one processor; a plurality of device-specific templates for a first user that each includes a plurality of user settings for the first user for a corresponding physical device; a master template corresponding to the first user that includes the plurality of user settings stored in the plurality of device-specific templates; mapping information residing in the memory for mapping the user settings for the first user in the plurality of device-specific templates to the master template and for mapping the user settings for the first user in the master template to the plurality of device-specific templates; and a user settings mechanism residing in the memory and executed by the at least one processor that receives a first user setting from a first physical device used by the first user, stores the first user setting in a first device-specific template corresponding to the first physical device, uses the mapping information to map the first user setting in the first device-specific template to a corresponding setting in the master template, and stores the corresponding setting in the master template.

The figures and disclosure herein further support a computer-implemented method executed by a processor for managing user settings, the method comprising: (A) selecting a physical device; (B) receiving from the physical device a plurality of user settings for a first user; (C) storing the plurality of user settings for the first user to a device-specific template corresponding to the selected physical device; (D) repeating steps (A), (B) and (C) for a plurality of physical devices to store the plurality of user settings for the first user to a corresponding plurality of device-specific templates; (E) reading mapping information that maps the plurality of user settings in each of the plurality of device-specific templates to a master template; and (F) storing the plurality of user settings in the plurality of device-specific templates to the master template.

The figures and disclosure herein further support a computer-implemented method executed by a processor for managing user settings, the method comprising: (A) selecting a physical device; (B) receiving from the physical device a plurality of user settings for a first user; (C) storing the plurality of user settings for the first user to a device-specific template corresponding to the selected physical device; (D) repeating steps (A), (B) and (C) for a plurality of physical devices to store the plurality of user settings for the first user to a corresponding plurality of device-specific templates; (E) reading mapping information that maps the plurality of user settings in each of the plurality of device-specific templates to a master template, wherein the mapping information comprises information for mapping user settings from the plurality of device-specific templates to a plurality of universal templates that correspond to a plurality of device types, and information for mapping user settings from the universal templates to the master template, wherein the master template includes a superset of all user settings for the first user stored in all of the plurality of device-specific templates and wherein the master template is a repository for all of the user settings for the first user, wherein each of the plurality of device types is defined by a combination of hardware architecture and system software, and wherein the combination of hardware architecture and system software for each universal template is different than the combination of hardware architecture and system software for other universal templates; (F) using the mapping information to store the plurality of user settings in the plurality of device-specific templates to the master template; (G) the first user storing a second user setting for the first user to the master template; (H) using the mapping information to map the second user setting in the master template to a corresponding setting in a second device-specific template; (I) using the mapping information to store the corresponding setting in the second device-specific template; and (J) storing the corresponding setting to a physical device corresponding to the second device-specific template.

While the implementation envisioned herein has the majority of storage for the user's information in the cloud, this cloud-based implementation may not be the ultimate end game. As technology advances, a handheld device like a smart phone could eventually have the capability of storing all of a user's information and could have sufficient computing capacity to perform all needed processing. Thus, the apparatus 300 shown in FIG. 3 could be representative of a handheld device, with the Universal Me system 100 running on the handheld device. In this scenario, when a user wants to program a television receiver or other device with the user's settings, the Universal Me app running on the user's smart phone could perform any needed conversion between different device types, and could download the settings to device via the smart phone's local interface (e.g., Bluetooth). As shown by this simple example, when the storage and computing capacity of smart phones becomes sufficiently large, most of the processing in the Universal Me system could be performed on the smart phone. The cloud would continue to be used for backup and for virtual devices, but much of the user's information could be stored on the user's smart phone, which could then be used to perform the many functions discussed herein without accessing the user's U-Me account in the cloud.

One of the long-term goals of the U-Me system is to create a place for all of a user's data, licensed content and settings. This includes settings for devices we have not yet dreamed of The philosophy is very simple. If the user is going to spend time configuring any device to the user's liking by specifying settings for the device, let's store those settings in the user's U-Me account so those settings can be used to reconfigure an identical or similar device, or so those settings can be used to generate suitable settings for a different kind of device. Thus, if a person spends hours configuring a computerized sewing machine to perform certain functions by specifying many different settings for the sewing machine, let's store those settings to the user's U-Me account. This philosophy can extend to any and all devices known today and developed in the future.

The specification herein uses different terms for phones, including cell phones, smart phones, and just “phones.” These are all examples of different mobile phones. The disclosure and claims herein expressly extend to any and all mobile phones, whether currently known or developed in the future.

The specification herein discusses different types of computing devices, including smart phones, tablets, laptop computers, and desktop computers. The term “computer system” or “computer” as used herein can extend to any or all of these devices, as well as other devices, whether currently known or developed in the future. In one specific context, a computer system is a laptop or desktop computer system, which is a different type than a phone or a tablet.

The disclosure herein uses some shortened terms for the sake of simplicity. For example, the word “information” is shortened in many instances to “info”, the word “photograph” is shortened in many instances to “photo”, the word “specifications” is shortened in some instances to “specs”, and the word “medications” is shortened in some instances to “meds.” Other shortened or colloquial terms may appear in the specification and drawings, which will be understood by those of ordinary skill in the art.

Many trademarks and service marks have been referenced in this patent application. Applicant has filed US federal service mark applications for “Universal Me” and for “U-Me”. All other trademarks and service marks herein are the property of their respective owners, and applicant claims no rights in these other marks.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a plurality of device-specific templates for a first user that each includes a plurality of user settings for the first user for a corresponding physical device;
a master template corresponding to the first user that includes the plurality of user settings stored in the plurality of device-specific templates;
mapping information residing in the memory for mapping the user settings for the first user in the plurality of device-specific templates to the master template and for mapping the user settings for the first user in the master template to the plurality of device-specific templates; and
a user settings mechanism residing in the memory and executed by the at least one processor that receives a first user setting from a first physical device used by the first user, stores the first user setting in a first device-specific template corresponding to the first physical device, uses the mapping information to map the first user setting in the first device-specific template to a corresponding setting in the master template, and stores the corresponding setting in the master template.

2. The apparatus of claim 1 wherein the user settings mechanism reads a second user setting for the first user from the master template, uses the mapping information to map the second user setting in the master template to a corresponding setting in a second device-specific template, stores the corresponding setting in the second device-specific template, and stores the corresponding setting to a physical device corresponding to the second device-specific template.

3. The apparatus of claim 1 wherein the master template includes a superset of all user settings for the first user stored in all of the plurality of device-specific templates and wherein the master template is a repository for all of the user settings for the first user.

4. The apparatus of claim 1 wherein the mapping information comprises information for mapping user settings from the plurality of device-specific templates to a plurality of universal templates that correspond to a plurality of device types, and information for mapping user settings from the universal templates to the master template.

5. The apparatus of claim 4 wherein each of the plurality of device types is defined by a combination of hardware architecture and system software.

6. The apparatus of claim 5 wherein the combination of hardware architecture and system software for each universal template is different than the combination of hardware architecture and system software for other universal templates.

7. The apparatus of claim 1 wherein the user settings mechanism uses the mapping information to map the corresponding setting in the master template to a second corresponding setting in a second device-specific template corresponding to the first user, stores the second corresponding setting to the second device-specific template, and stores the second corresponding setting to a second physical device corresponding to the second device-specific template.

8. The apparatus of claim 7 wherein the first physical device has a first combination of hardware architecture and system software and the second physical device has a second combination of hardware architecture and system software different than the first combination of hardware architecture and system software.

9. A computer-implemented method executed by a processor for managing user settings, the method comprising:
(A) selecting a physical device;
(B) receiving from the physical device a plurality of user settings for a first user;
(C) storing the plurality of user settings for the first user to a device-specific template corresponding to the selected physical device;
(D) repeating steps (A), (B) and (C) for a plurality of physical devices to store the plurality of user settings for the first user to a corresponding plurality of device-specific templates;
(E) reading mapping information that maps the plurality of user settings in each of the plurality of device-specific templates to a master template; and
(F) storing the plurality of user settings in the plurality of device-specific templates to the master template.

10. The method of claim 9 further comprising:
reading a second user setting from the master template;
using the mapping information to map the second user setting in the master template to a corresponding setting in a second device-specific template;
storing the corresponding setting in the second device-specific template; and
storing the corresponding setting to a physical device corresponding to the second device-specific template.

11. The method of claim 9 wherein the master template includes a superset of all user settings for the first user stored in all of the plurality of device-specific templates and wherein the master template is a repository for all of the user settings for the first user.

12. The method of claim 9 wherein the mapping information comprises information for mapping user settings from the plurality of device-specific templates to a plurality of universal templates that correspond to a plurality of device types, and information for mapping user settings from the universal templates to the master template.

13. The method of claim 12 wherein each of the plurality of device types is defined by a combination of hardware architecture and system software.

14. The method of claim 13 wherein the combination of hardware architecture and system software for each universal template is different than the combination of hardware architecture and system software for other universal templates.

15. The method of claim 9 further comprising:
using the mapping information to map the corresponding setting in the master template to a second corresponding setting in a second device-specific template corresponding to the first user;
storing the second corresponding setting to the second device-specific template; and
storing the second corresponding setting to a second physical device corresponding to the second device-specific template.

16. The method of claim 15 wherein the first physical device has a first combination of hardware architecture and system software and the second physical device has a second combination of hardware architecture and system software different than the first combination of hardware architecture and system software.

17. A computer-implemented method executed by a processor for managing user settings, the method comprising:
(A) selecting a physical device;
(B) receiving from the physical device a plurality of user settings for a first user;
(C) storing the plurality of user settings for the first user to a device-specific template corresponding to the selected physical device;
(D) repeating steps (A), (B) and (C) for a plurality of physical devices to store the plurality of user settings for the first user to a corresponding plurality of device-specific templates;
(E) reading mapping information that maps the plurality of user settings in each of the plurality of device-specific templates to a master template, wherein the mapping information comprises information for mapping user settings from the plurality of device-specific templates to a plurality of universal templates that correspond to a plurality of device types, and information for mapping user settings from the universal templates to the master template, wherein the master template includes a superset of all user settings for the first user stored in all of the plurality of device-specific templates and wherein the master template is a repository for all of the user settings for the first user, wherein each of the plurality of device types is defined by a combination of hardware architecture and system software, and wherein the combination of hardware architecture and system software for each universal template is different than the combination of hardware architecture and system software for other universal templates;
(F) using the mapping information to store the plurality of user settings in the plurality of device-specific templates to the master template;
(G) the first user storing a second user setting for the first user to the master template;
(H) using the mapping information to map the second user setting in the master template to a corresponding setting in a second device-specific template;
(I) using the mapping information to store the corresponding setting in the second device-specific template; and
(J) storing the corresponding setting to a physical device corresponding to the second device-specific template.

18. The method of claim 17 wherein the first physical device has a first combination of hardware architecture and system software and the second physical device has a second combination of hardware architecture and system software different than the first combination of hardware architecture and system software.
